(19) United States
(12) Patent Application Publication
(10) Pub. No.: US 2022/0403200 A1
(43) Pub. Date: Dec. 22, 2022

(54) MULTI-FLUID KIT FOR TEXTILE PRINTING

(71) Applicant: HEWLETT-PACKARD DEVELOPMENT COMPANY, L.P., Spring, TX (US)

(72) Inventors: Zhang-Lin Zhou, San Diego, CA (US); Qianhan Yang, San Diego, CA (US)

(21) Appl. No.: 17/340,995

(22) Filed: Jun. 7, 2021

(51) Int. Cl. C09D 11/54; C09D 11/322; C09D 11/38; C09D 11/037; C09D 11/033; C09D 11/102; D06P 5/30; D06P 5/00; D06P 1/52; B41M 5/00; B41M 7/00

(52) U.S. Cl. CPC C09D 11/54; C09D 11/322; C09D 11/38; C09D 11/037; C09D 11/033; C09D 11/102; D06P 5/30; D06P 5/002; D06P 1/5285; B41M 5/0017; B41M 5/0023; B41M 5/0047; B41M 7/009

(57) ABSTRACT

A multi-fluid kit for textile printing includes an inkjet ink and a fixer fluid. The inkjet ink includes a self-crosslinked polyurethane binder particle including a polyurethane polymer with a polymerized carboxylate-based diol and a polymerized sulfonated diamine, a pigment, and an ink aqueous vehicle; and a fixer fluid includes an azetidinium-containing polyamine, and a fixer aqueous vehicle.

### BACKGROUND

Textile printing methods often include rotary and/or flat-screen printing. Traditional analog printing typically involves the creation of a plate or a screen, i.e., an actual physical image from which ink is transferred to the textile. Both rotary and flat screen printing have high volume throughput capacity, but also have limitations on the maximum image size that can be printed. For large images, pattern repeats are used. Conversely, digital inkjet printing enables greater flexibility in the printing process, where images of any desirable size can be printed immediately from an electronic image without pattern repeats. Inkjet printers are gaining acceptance for digital textile printing. Inkjet printing is a non-impact printing method that utilizes electronic signals to control and direct droplets or a stream of ink to be deposited on media.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic illustration of example multi-fluid kits and example textile printing kits, each of which includes an example of an inkjet ink and an example of a fixer fluid;

FIG. 2 is a schematic illustration of a portion of a polyurethane polymer of the self-crosslinked polyurethane binder particles disclosed herein;

FIG. 3 illustrates an example of a chemical structure for the portion shown in FIG. 2;

FIG. 4 is a flow diagram illustrating an example of a method for printing a printed image on a textile fabric;

FIG. 5 is a schematic diagram of an example of a printing system; and

FIG. 6 depicts Turn-On-Energy (TOE) curves for seven example black inkjet inks, and two comparative example black inkjet inks, plotting drop weight in nanograms (ng) vs. firing energy in microJoules (μJ).

### DETAILED DESCRIPTION

The textile is a major industry, and printing on textiles, such as cotton, polyester, etc., has been evolving to include digital printing methods. Some digital printing methods enable direct to garment (or other textile) printing. In order to achieve a textile print with good wash durability, binders have been included in the inkjet ink and/or in other fluids that are printed with the inkjet ink. Some binders are jettable but have issues in terms of wet crock-fastness, and/or pose challenges when thermally inkjet printed (e.g., poor jettability, clogging printheads, etc.).

Disclosed herein is a multi-fluid kit that is particularly suitable for obtaining printed images, which may have desirable opacity, durability (i.e., washfastness), wet crock-fastness, and/or quality. Examples of the multi-fluid kit include at least a fixer fluid and an inkjet ink. The inkjet ink includes polyurethane polymer particles, which have been found to increase the wet crock-fastness, particularly of black inks, on cotton and polyester textile fabrics. The polyurethane polymer particles include both sulfonate and carboxylate stabilization on the backbone. The sulfonate stabilization is imparted by a sulfonated diamine, which introduces a sulfonic acid group as a side chain on the polyurethane polymer backbone, which can undergo a ring opening reaction with the azetidinium ring of the polyamine of the fixer fluid (see Scheme I below). The carboxylate stabilization is imparted by a carboxylate-based diol, which introduces a carboxylic acid group as a side chain on the polyurethane polymer backbone, which can also undergo a ring opening reaction with the azetidinium ring of the polyamine of the fixer fluid (Scheme II). As such, images formed with the multi-fluid kit exhibit good washfastness and improved wet crock-fastness. Some comparative polyurethane polymer particles include a higher number of carboxylate groups without sulfonate groups, but these particles have been found to have a reduced particle size which adversely affects the jettability of the inkjet ink. The current inventors have found adding a controlled amount of carboxylate groups improves the wet crock-fastness of inkjet inks, particularly black inks, while maintaining jettability.

The opacity may be measured in terms of L*, i.e., lightness, of a printed image generated on a textile fabric. A greater L* value indicates a greater opacity of the ink on the textile fabric. L* is measured in the CIELAB color space, and may be measured using any suitable color measurement instrument (such as those available from HunterLab or X-Rite). The inkjet ink, when printed on the textile fabric and the fixer fluid disclosed herein, may generate prints that have a desirable L* value.

The durability of a print on a textile fabric may be assessed by its ability to retain color after being exposed to washing. This is also known as washfastness. Washfastness can be measured in terms of a change in L* before and after washing.

The durability of a print on a textile fabric may also be assessed by its ability to resist ink removal when rubbed with a wet cloth. This is also known as wet crock-fastness. Wet crock-fastness is evaluated visually with an American Association of Textile Chemists and Colorists (AATCC) color chart, and rated on a scale from 1-5.

The fluid(s) and/or inkjet ink disclosed herein may include different components with different acid numbers. As used herein, the term “acid number” refers to the mass of potassium hydroxide (KOH) in milligrams that is used to neutralize one (1) gram of a particular substance. The test for determining the acid number of a particular substance may vary, depending on the substance. An example of such as test for polyurethane is described below.

Throughout this disclosure, a weight percentage that is referred to as “wt % active” refers to the loading of an active component of a dispersion or other formulation that is present in the fixer fluid, or the inkjet ink. For example, the pigment may be present in a water-based formulation (e.g., a stock solution or dispersion) before being incorporated into the inkjet ink. In this example, the wt % actives of the pigment accounts for the loading (as a weight percent) of the pigment that is present in the inkjet ink, and does not account for the weight of the other components (e.g., water, etc.) that are present in the water-based formulation with the pigment.

The term “molecular weight” as used herein refers to weight average molecular weight (Mw), the units of which are g/mol or Daltons.

The viscosity measurements set forth herein represent those measured by a viscometer at a particular temperature and at a particular shear rate (s⁻¹) or at a particular speed. The temperature and shear rate or temperature and speed are identified with individual values. Viscosity may be measured, for example, by a Brookfield viscometer or another suitable instrument.

### Sets and Kits

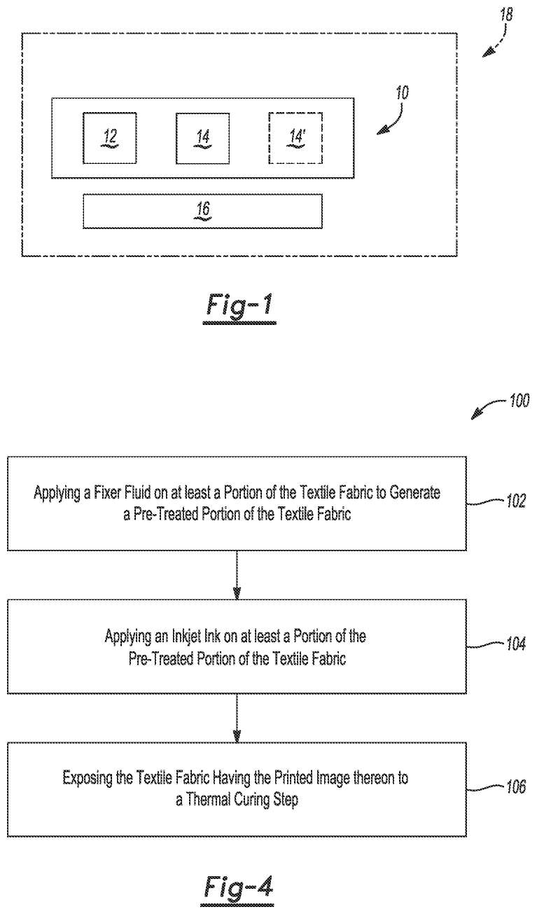

Examples of the multi-fluid kit disclosed herein are shown schematically in FIG. 1. As depicted, one example of the multi-fluid kit 10 comprises a fixer fluid 12 including an azetidinium-containing polyamine and a fixer aqueous vehicle; and an inkjet ink 14 including a self-crosslinked polyurethane binder particle including a polyurethane polymer with a polymerized carboxylate-based diol and a polymerized sulfonated diamine; a pigment; and an ink aqueous vehicle.

It is to be understood that any example of the fixer fluid 12, and the inkjet ink 14 disclosed herein may be used in the examples of the multi-fluid kit 10.

In the examples disclosed herein, the multi-fluid kit 10 includes the fixer fluid 12 that may be formulated for either analog application (e.g., by a squeegee, a roller, a sprayer, or a screen) or digital inkjet printing (e.g., by thermal or piezoelectric inkjet printing), and an inkjet ink 14 that is formulated for digital printing.

When used in a thermal inkjet printer, the viscosity of the fixer fluid 12 may be modified to range from about 1 centipoise (cP) to about 9 cP (at 20° C. to 25° C.). In some specific examples, the thermal inkjet printable fixer composition has a viscosity ranging from about 2 cP to about 3 cP. When used in a piezoelectric printer, the viscosity of the fixer fluid 12 may be modified to range from about 2 cP to about 20 cP (at 20° C. to 25° C.), depending on the viscosity of the printhead that is being used (e.g., low viscosity printheads, medium viscosity printheads, or high viscosity printheads). When applied using analog methods, the viscosity for the fixer fluid 12 may range from about 5 cP to about 1000 cP.

In any example of the fluid kit 10, the fixer fluid 12 and the inkjet ink 14 may be maintained in separate containers (e.g., respective reservoirs/fluid supplies of respective inkjet cartridges) or separate compartments (e.g., respective reservoirs/fluid supplies) in a single container (e.g., inkjet cartridge).

Some examples of the multi-fluid kit 10 include a single inkjet ink 14 of any desirable color, or may include multiple inkjet inks 14, 14′ of different colors (described below).

Examples of the fluid kit 10 may also be part of a kit 18 for textile printing, which is also shown schematically in FIG. 1. In an example, the textile printing kit 18 includes a textile fabric 16, a fixer fluid 12 including an azetidinium-containing polyamine and a fixer aqueous vehicle; and an inkjet ink 14 including a self-crosslinked polyurethane binder particle including a polyurethane polymer with a polymerized carboxylate-based diol and a polymerized sulfonated diamine; a pigment; and an ink aqueous vehicle.

It is to be understood that any example of the fixer fluid 12, the inkjet ink 14, and the textile fabric 16 disclosed herein may be used in the examples of the textile printing kit 18.

### Inkjet Ink

The inkjet ink 14 disclosed herein includes a self-crosslinked polyurethane binder particle including a polyurethane polymer with a polymerized carboxylate-based diol and a polymerized sulfonated diamine; a pigment; and an ink aqueous vehicle. In some instances, the inkjet ink consists of these components. In other instances, the inkjet ink 14 may include other additives or components. The following description refers specifically to the inkjet ink 14, but it is to be understood that this description is also applicable for the inkjet ink 14′ which has a different color than the inkjet ink 14.

The inkjet ink 14 includes a self-crosslinked polyurethane binder particle, which includes a polymerized carboxylate-based diol and polymerized sulfonated diamine.

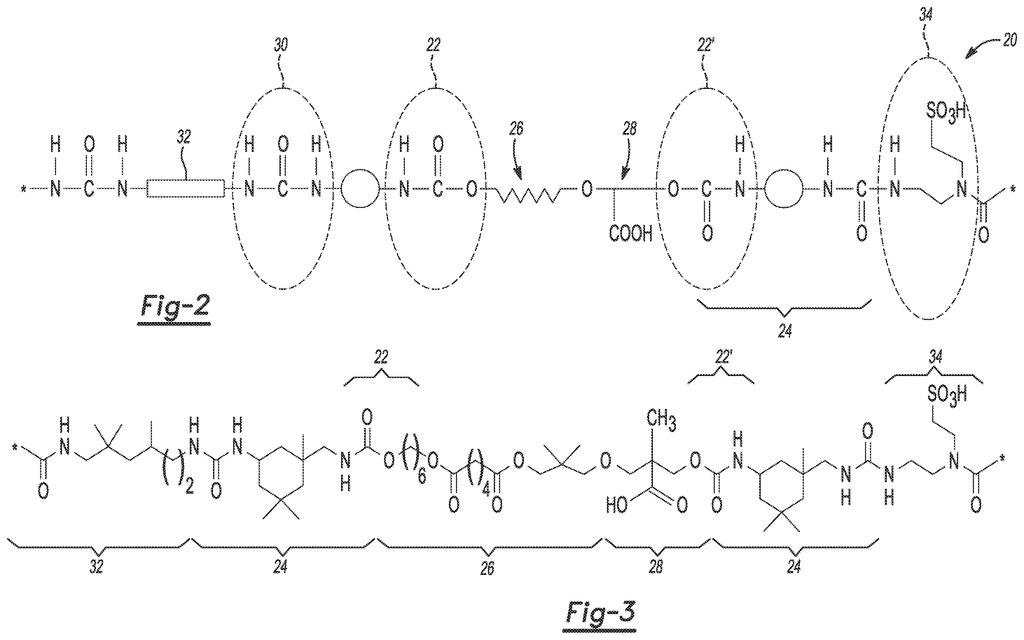

FIG. 2 depicts a portion of the polyurethane polymer 20 that can be present as part of the polyurethane particles described herein. FIG. 2 does not show the crosslinking, but rather shows the types of groups of moieties that can be present along the polyurethane polymer 20, some of which are available for internal crosslinking.

The polyurethane polymer structure 20 in FIG. 2 includes several chemical moieties, such as urethane linkage groups 22, 22′ (formed by the reaction of isocyanate groups 24 with any of a number of polymeric diols 26 or carboxylate-based diols 28 that may be present). A carbon atom of an isocyanate group 24 reacts with an oxygen atom of a hydroxyl of the polymeric diol 26 to form the urethane linkage group 22. A carbon atom of an isocyanate group 24 can also react with an oxygen atom of a hydroxyl of the carboxylate-based diol 28 to form the urethane linkage group 22′. The polymeric diols 26, the carboxylate-based diols 28, and the isocyanate groups 24 are show schematically after polymerization. The isocyanate groups 24 are shown along the polyurethane backbone, and are schematically represented by a circle with isocyanate groups on either side thereof. Other chemical moieties represented in FIG. 2 include a urea group 30 (formed by the reaction of isocyanate groups 24 with any of a number of diamines that may be present), a non-ionic diamine 32, and a sulfonated diamine 34. The amines of the non-ionic diamine 32 and the sulfonated diamine 34 are present along the polymer backbone, and the sulfonate group of the sulfonated diamine 34 is included in a side chain (e.g. —(CH₂)ₓSO₃H) off the polymer backbone and/or as an end group.

The polyurethane polymer structure 20 shown in FIG. 2 is not intended to depict a specific polymer, but rather show and example of the sulfonated side chain and the polyurethane backbone. It is contemplated that the polyurethane polymer structure 20 may include additional polymerized isocyanates 24, polymerized polymeric diols 26, polymerized carboxylate-based diols 28, polymerized non-ionic diamines 32, polymerized sulfonated diamines 34, urethane linkage groups 22, urea linkage groups 30, etc. Additionally, the diamines 32, 34 may be in different positions along the polymer backbone depending on the respective reactions with the isocyanates 24.

FIG. 3 depicts a portion of an example polyurethane polymer 20 formed with isophorone diisocyanate, a polyester polyol, tetramethylethylenediamine (a non-ionic diamine), an amine functionalized sulfonic acid (e.g., A-95 from Evonik Industries), and dimethylol propionic acid (e.g., DMPA from GEO Specialty Chemicals).

As used herein, the terms “polymerized polymeric diols,” “polymerized carboxylated based diols,” “polymerized isocyanates,” “polymerized non-ionic diamines,” and “polymerized sulfonated diamines” refer to the respective monomers in their polymerized states (e.g., after the monomers have bonded together to form a polyurethane chain). It is to be understood that the monomers change in certain ways during polymerizing, and do not exist as separate molecules in the polymer.

The self-cross-linked polyurethane binder particles may be synthesized by reacting the diisocyanate with the polymeric diol and carboxylate-based diol in the presence of a catalyst in a solvent under reflux to create a pre-polymer; and reacting the pre-polymer with the non-ionic diamine and the sulfonated diamine. In an example, the resulting polyurethane polymer 20 consists of the polymerized sulfonated diamine, the polymerized diisocyanate, the polymerized polymeric diol, the polymerized carboxylate-based diol, and the polymerized non-ionic diamine. In another example, the resulting polyurethane polymer 20 consists of the polymerized sulfonated diamine, the polymerized diisocyanate, and the polymerized carboxylate-based diol.

In one example, making the self-crosslinked polyurethane binder particles involves first reacting the diisocyanate with the polymeric diol and the carboxylate-based diol. This reaction may occur in the presence of a catalyst (e.g., dibutyl tin dilaurate, bismuth octanoate, and 1,4-diazabicyclo[2.2.2]octane) and in an organic solvent (e.g., methyl ethyl ketone (MEK), tetrahydrofuran (THF), ethyl acetate, acetone, or combinations thereof) under reflux. This reaction forms a pre-polymer having urethane linkages. The pre-polymer is dissolved in the organic solvent.

Some example diisocyanates include hexamethylene-1,6-diisocyanate (HDI), 2,2,4-trimethyl-hexamethylene-diisocyanate (TDMI), 1,12-dodecane diisocyanate, 2,4,4-trimethyl-hexamethylene diisocyanate, 2-methyl-1,5-pentamethylene diisocyanate, isophorone diisocyanate (IPDI), methylene diphenyl diisocyanate (MDI), 1-Isocyanato-4-[(4-isocyanatocyclohexyl)methyl]cyclohexane) (H12MDI, i.e., 4,4′-Methylenedicyclohexyl diisocyanate), and combinations thereof. In some instances, it may be desirable to use an aliphatic diisocyanate.

Suitable polymeric diols include a polyester diol, a polycarbonate diol, a polyether diol, or combinations thereof. An example of a suitable commercially available polyester diol is STEPANPOL® PC-1015-55 (a solvent-free saturated polyester resin available from Stepan Co.). An example of a suitable commercially available polycarbonate polyol is ETERNACOLL® UH200 (a solvent-free solid aliphatic polycarbonate diol from UBE Industries, Ltd.).

An example of the polyester diol is a polyadipate polyol, which is an aliphatic polyol formed from a polyalcohol and adipic acid, shown below in Formula 1:

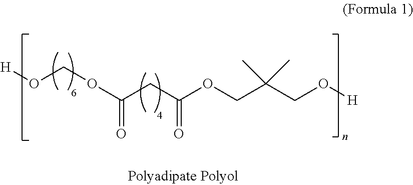

where n may be 2 to 8. An example of this is STEPANOL® PC-1015-55, available from Stepan Company.

Another example of the polyester diol is a polysebacate polyol, which is an aliphatic polyol formed from a polyalcohol and sebacic acid, shown below in Formula 2:

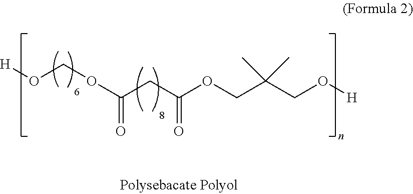

where n may be 2 to 7. An example of this polyol is KURARAY® P-2050 sold by Kuraray.

Examples of the carboxylate-based diol include dimethylol propionic acid:

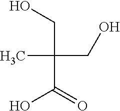

or dimethylol butanoic acid:

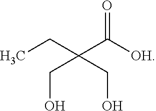

In the polyurethane, the polymerized carboxylate-based diol includes polymerized dimethylol propionic acid or polymerized dimethylol butanoic acid.

During this reaction, the amount of carboxylate-based diol is selected to control the acid number of the final polyurethane polymer so that it is 10 or less.

During this reaction, the diisocyanate is used in excess so that additional NCO groups are available for subsequent cross-linking.

The pre-polymer is then chain extended and/or cross-linked. Chain extension and/or cross-linking may be accomplished by adding water and the diamines to the pre-polymer solution. With respect to the diamines that can be used in forming the polyurethane polymer and particles as described herein, sulfonated-diamines, alone or in combination with non-ionic diamines can be used.

Sulfonated-diamines can be prepared from diamines by adding sulfonate groups thereto. Non-ionic diamines can be diamines that include aliphatic groups that are not charged, such as alkyl groups, alicyclic groups, etc. Example diamines can include various dihydrazides, alkyldihydrazides, sebacic dihydrazides, alkyldioic dihydrazides, aryl dihydrazides, e.g., terephthalic dihydrazide, organic acid dihydrazide, e.g., succinic dihydrazides, adipic acid dihydrazides, etc, oxalyl dihydrazides, azelaic dihydrazides, carbohydrazide, etc. It is noted however that these examples may not be appropriate for use as one or the other type of diamine, but rather, this list is provided as being inclusive of the types of diamines that can be used in forming the sulfonated-diamines and/or the non-ionic diamines, and not both in every instance (though some can be used for either type of diamine).

Example diamine structures are shown below. More specific examples of diamines include 4,4′-methylenebis(2-methylcyclohexyl-amine) (DMDC), 4-methyl-1,3′-cyclohexanediamine (HTDA), 4,4′-Methylenebis(cyclohexylamine) (PACM), isphorone diamine (IPDA), tetramethylethylenediamine (TMDA), ethylene diamine (DEA), 1,4-cyclohexane diamine, 1,6-hexane diamine, hydrazine, adipic acid dihydrazide (AAD), and/or carbohydrazide (CHD). Many of the diamine structures shown below can be used as the non-ionic diamine, such as the uncharged aliphatic diamines shown below.

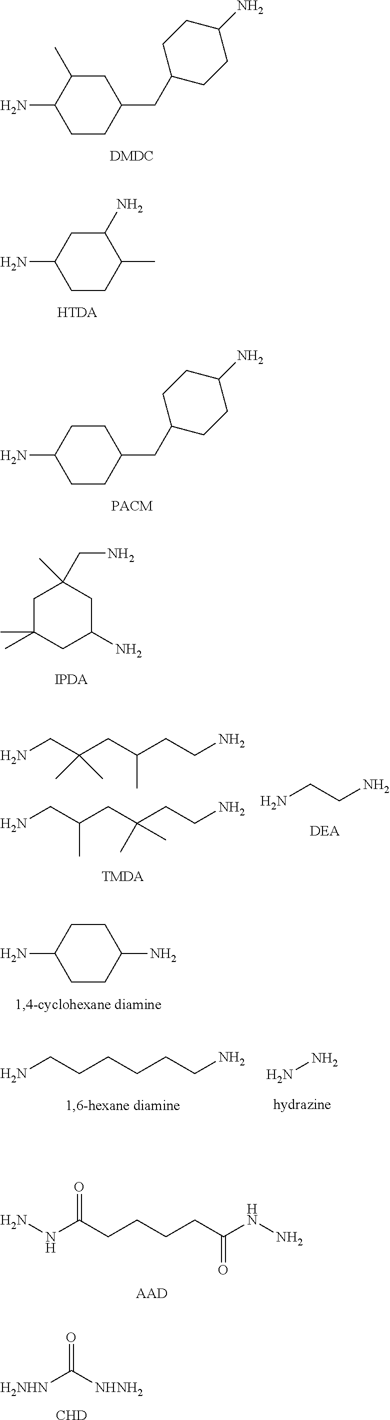

There are also other alkyl diamines (other than 1,6-hexane diamine) that can be used, such as, by way of example:

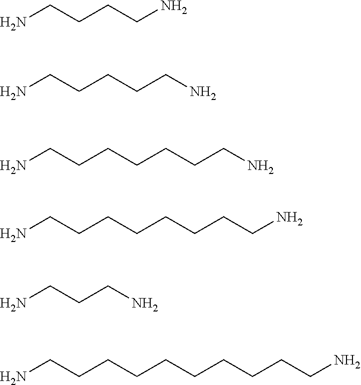 [SMILES: NCCCCN ; NCCCCCN ; NCCCCCCCN ; NCCCCCCCCN ; NCCCN ; NCCCCCCCCCCN]

There are also other dihydrazides (other than AAD shown above) that can be used, such as, by way of example:

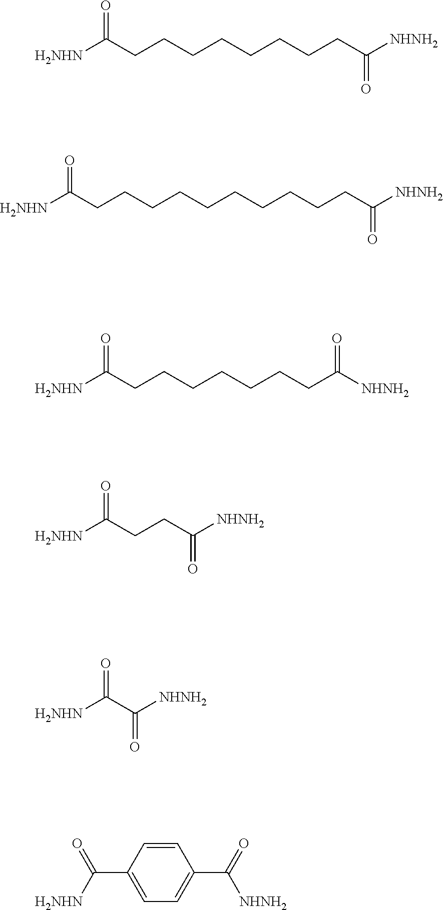

An example of the sulfonated diamine is an alkylamine-alkylamine-sulfonate (shown as a sulfonic acid in Formula 3 below, but as a sulfonate, would include a positive counterion associated with an SO₃⁻ group). While one example is shown in Formula 3 below, it is to be understood that other diamines may be used to generate a sulfonated diamine, including those based on structures shown above.

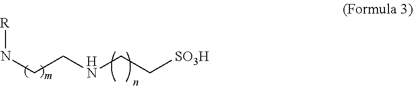

where R is H or is a C1 to C10 straight-or branched-alkyl or alicyclic or combination of alkyl and alicyclic, m is 1 to 5, and n is 1 to 5. One example of such a structure, sold by Evonik Industries (USA), is A-95, which is exemplified where R is H, m is 1, and n is 1. Another example structure sold by Evonik Industries is VESTAMIN®, where R is H, m is 1, and n is 2.

The sulfonated diamine provides the polyurethane polymer with a polar stabilizing functional group, which is able to couple with polar aqueous groups (e.g., water) to form a stable dispersion that does not precipitate out. In some instances, the polyurethane polymer is formed with the sulfonated diamine and without the non-ionic diamine.

After the chain extension and/or cross-linking reactions, any solvent is then removed, e.g., by vacuum distillation to afford the final polyurethane dispersion (i.e., self-cross-linked polyurethane binder particles (with a polymerized carboxylate-based diol and a polymerized sulfonated diamine) dispersed in water). More specifically, the polyurethane solution may be slowly added to water including a base with vigorous agitation, or vice versa. The mixture may be stirred and the organic solvent may be removed by distillation to form the polyurethane binder particles in dispersion.

In an example, the polyurethane polymer 20 has an acid number of 10 or less, a weight average molecular weight ranging from about 25,000 g/mol to about 1,000,000 g/mol, and a particle size ranging from about 150 nm to about 350 nm.

In an example, the acid number of the polyurethane polymer 20 is 10 mg KOH/g solid resin or less, or 8 mg KOH/g solid resin or less. As examples, the self-cross-linked polyurethane polymer 20 may have an acid number ranging from greater than 0 mg KOH/g to 10 mg KOH/g, or from greater than 0 mg KOH/g to about 8 mg KOH/g, or from greater than 0 mg KOH/g to about 6 mg KOH/g, or from greater than 0 mg KOH/g to about 4 mg KOH/g, or from greater than 0 mg KOH/g to about 2 mg KOH/g, etc. As used herein, the term “acid number” refers to the mass of potassium hydroxide (KOH) in milligrams that is used to neutralize one (1) gram of a particular substance (e.g., the polyurethane polymer 20). The test for determining the acid number of a particular substance may vary, depending on the substance. For example, to determine the acid number of the polyurethane polymer 20, a known amount of a sample of the polyurethane polymer 20 (e.g., in the form of the binder particles) may be dispersed in water and the aqueous dispersion may be titrated with a polyelectrolyte titrant of a known concentration. In this example, a current detector for colloidal charge measurement may be used. An example of a current detector is the Mütek PCD-05 Smart Particle Charge Detector (available from BTG). The current detector measures colloidal substances in an aqueous sample by detecting the streaming potential as the sample is titrated with the polyelectrolyte titrant to the point of zero charge. An example of a suitable polyelectrolyte titrant is poly(diallyldimethylammonium chloride) (i.e., PolyDADMAC). It is to be understood that any suitable test for a particular component may be used.

The weight average molecular weight of the self-cross-linked polyurethane binder particles may range from about 25,000 g/mol to about 1,000,000 g/mol. In an example, the weight average molecular weight of the self-cross-linked polyurethane binder particles may range from about 25,000 g/mol to about 1,000,000 g/mol, or from about 50,000 g/mol to about 500,000 g/mol, or from about 100,000 g/mol to about 500,000 g/mol.

The average particle size (volume-weighted mean diameter) of the self-cross-linked polyurethane binder particles may range from about 150 nm to about 350 nm. In one example, this range refers to the D50 particle size of a particle distribution (half of the particles in the distribution are above the D50 value and half the particle in the distribution are below the D50 value). In an example, the self-cross-linked polyurethane binder particles may have a D50 particle size ranging from about 150 nm to about 350 nm.

The self-cross-linked polyurethane binder particles may be incorporated into the inkjet ink as a polyurethane dispersion, and any liquid components of the dispersion become part of the ink aqueous vehicle. The polyurethane dispersion is added in a suitable amount so that the desired solids content of self-cross-linked polyurethane binder particles is achieved in the inkjet ink 14. In an example, the self-cross-linked polyurethane binder particles (which does not account for other dispersion components) are present in an amount ranging from about 0.1 wt % active to about 30 wt % active based on a total weight of the inkjet ink 14. In other examples, the self-cross-linked polyurethane binder particles are present in an amount ranging from about 1 wt % active to about 25 wt % active, or from about 5 wt % active to about 20 wt % active, or from about 10 wt % active to about 14 wt % active, based on the total weight of the inkjet ink 14.

The self-cross-linked polyurethane binder particles may be formed from any of the example isocyanates, polyols (including the carboxylate-based diols), diamines, and sulfonated diamines set forth herein. Table A illustrates some examples of the components used to make different examples of the carboxylated and sulfonated polyurethane. Table B illustrates some example properties of the carboxylated and sulfonated polyurethanes described in Table A.

The following abbreviations are used in Tables A and B: IPDI=Isophorone diisocyanate; TMDI=Tetramethylxylene diisocyanate; H6XDI=1,4-bis(isocyanatomethyl)cyclohexane; DMPA=dimethylol propionic acid; DMBA=dimethylol butanoic acid; PEP=polyester polyol (e.g., STEPANPOL® PC-1015-55); IPDA=isophorone diamine; TMDA=2,4,4-trimethylhexane-1,6-diamine, and AN=acid number.

TABLE A
Components of Sulfonated and Carboxylated Polyurethane Dispersion Examples

| | A-95 | DMPA | DMBA | PEP | IPDA | IPDI | TMDI | TMDA |
|---|---|---|---|---|---|---|---|---|
| Binder | (%) | (%) | (%) | (%) | (%) | (%) | (%) | (%) |
| Binder 1 | 2.973 | 0.21 | — | 72.468 | — | 20.527 | — | 3.822 |
| Binder 2 | 2.966 | 0.418 | — | 72.316 | — | 20.484 | — | 3.814 |
| Binder 3 | 1.794 | 0.834 | — | 72.867 | — | 20.643 | — | 3.844 |
| Binder 4 | 2.407 | 0.424 | — | 73.351 | 4.162 | — | 19.655 | — |
| Binder 5 | 2.089 | — | 0.697 | 72.764 | — | 20.611 | — | 3.838 |
| Binder 6 | 1.792 | — | 0.931 | 72.812 | — | 20.625 | — | 3.84 |
| Binder 7 | 2.705 | — | 0.234 | 73.27 | 4.158 | — | 19.633 | — |
| Binder 8 | 2.406 | — | 0.469 | 73.368 | 4.163 | — | 19.646 | — |
| Binder 9 | 2.411 | — | 0.703 | 73.319 | 4.16 | — | 19.659 | — |

TABLE B
Properties of Sulfonated and Carboxylated
Polyurethane Dispersion Examples

| | Total | Particle | | |
|---|---|---|---|---|
| | solids | size | | |
| Binder | (%) | (nm) | PH | AN |
| Binder 1 | 32.84 | 108.7 | 7.5 | 9.6 |
| Binder 2 | 29.4 | 97.34 | 7.5 | 10.5 |
| Binder 3 | 32.37 | 218.3 | 7.5 | 8.8 |
| Binder 4 | 32.59 | 201.3 | 7.5 | 8.9 |
| Binder 5 | 31.08 | 238.4 | 8 | 8.8 |
| Binder 6 | 30.96 | 258.2 | 8 | 8.8 |
| Binder 7 | 24.59 | 267.6 | 7 | 8.9 |
| Binder 8 | 19.9 | 231.8 | 7 | 8.9 |
| Binder 9 | 18.3 | 664.4 | 7 | 8.9 |

The inkjet ink 14 includes a pigment. The pigment may be incorporated into the ink vehicle to form the inkjet ink 14. The pigment may be incorporated as a pigment dispersion. The pigment dispersion may include a pigment and a separate pigment dispersant.

For the pigment dispersions disclosed herein, it is to be understood that the pigment and separate pigment dispersant (prior to being incorporated into the ink vehicle to form the inkjet ink 14), may be dispersed in water alone or in combination with an additional water soluble or water miscible co-solvent, such as 2-pyrrolidone, 1-(2-hydroxyethyl)-2-pyrrolidone, glycerol, 2-methyl-1,3-propanediol, 2,2-dimethyl-1,3-propanediol, 1,2-butane diol, diethylene glycol, 1,3-propanediol, 1,4-butanediol, 1,5-pentanediol, triethylene glycol, tetraethylene glycol, hexylene glycol, or a combination thereof. It is to be understood however, that the liquid components of the pigment dispersion become part of the ink vehicle in the inkjet ink 14.

As used herein, “pigment” generally includes organic or inorganic pigment colorants, magnetic particles, aluminas, silicas, and/or other ceramics, organo-metallics or other opaque particles, whether or not such particulates impart color. Thus, although the present description primarily illustrates the use of pigment colorants, the term “pigment” can be used more generally to describe pigment colorants, as well as other pigments, such as organometallics, ferrites, ceramics, etc.

In some examples, the pigment may be a cyan, magenta, black or yellow pigment.

Examples of suitable pigments include the following, which are available from BASF Corp.: PALIOGEN® Orange, HELIOGEN® Blue L 6901F, HELIOGEN® Blue NBD 7010, HELIOGEN® Blue K 7090, HELIOGEN® Blue L 7101F, PALIOGEN® Blue L 6470, HELIOGEN® Green K 8683, HELIOGEN® Green L 9140, CHROMOPHTAL® Yellow 3G, CHROMOPHTAL® Yellow GR, CHROMOPHTAL® Yellow 8G, IGRAZIN® Yellow 5GT, and IGRALITE® Rubine 4BL. The following pigments are available from Degussa Corp.: Color Black FWI, Color Black FW2, Color Black FW2V, Color Black 18, Color Black, FW200, Color Black 5150, Color Black S160, and Color Black 5170. The following black pigments are available from Cabot Corp.: REGAL® 400R, REGAL® 330R, REGAL® 660R, MOGUL® L, BLACK PEARLS® L, MONARCH® 1400, MONARCH® 1300, MONARCH® 1100, MONARCH® 1000, MONARCH® 900, MONARCH® 880, MONARCH® 800, and MONARCH® 700. The following pigments are available from Orion Engineered Carbons GMBH: PRINTEX® U, PRINTEX® V, PRINTEX® 140U, PRINTEX® 140V, PRINTEX® 35, Color Black FW 200, Color Black FW 2, Color Black FW 2V, Color Black FW 1, Color Black FW 18, Color Black S 160, Color Black S 170, Special Black 6, Special Black 5, Special Black 4A, and Special Black 4. The following pigment is available from DuPont: TI-PURE® R-101. The following pigments are available from Heubach: MONASTRAL® Magenta, MONASTRAL® Scarlet, MONASTRAL® Violet R, MONASTRAL® Red B, and MONASTRAL® Violet Maroon B. The following pigments are available from Clariant: DALAMAR® Yellow YT-858-D, Permanent Yellow GR, Permanent Yellow G, Permanent Yellow DHG, Permanent Yellow NCG-71, Permanent Yellow GG, Hansa Yellow RA, Hansa Brilliant Yellow 5GX-02, Hansa Yellow-X, NOVOPERM® Yellow HR, NOVOPERM® Yellow FGL, Hansa Brilliant Yellow 10GX, Permanent Yellow G3R-01, HOSTAPERM® Yellow H4G, HOSTAPERM® Yellow H3G, HOSTAPERM® Orange GR, HOSTAPERM® Scarlet GO, and Permanent Rubine F6B. The following pigments are available from Sun Chemical: QUINDO® Magenta, INDOFAST® Brilliant Scarlet, QUINDO® Red R6700, QUINDO® Red R6713, INDOFAST® Violet, L74-1357 Yellow, L75-1331 Yellow, L75-2577 Yellow, and LHD9303 Black. The following pigments are available from Birla Carbon: RAVEN® 7000, RAVEN® 5750, RAVEN® 5250, RAVEN® 5000 Ultra® II, RAVEN® 2000, RAVEN® 1500, RAVEN® 1250, RAVEN® 1200, RAVEN® 1190 Ultra®. RAVEN® 1170, RAVEN® 1255, RAVEN® 1080, and RAVEN® 1060. The following pigments are available from Mitsubishi Chemical Corp.: No. 25, No. 33, No. 40, No. 47, No. 52, No. 900, No. 2300, MCF-88, MA600, MA7, MA8, and MA100. The colorant may be a white pigment, such as titanium dioxide, or other inorganic pigments such as zinc oxide and iron oxide.

Specific examples of a cyan color pigment may include C.I. Pigment Blue -1, -2, -3, -15, -15:1, -15:2, -15:3, -15:4, -16, -22, and -60.

Specific examples of a magenta color pigment may include C.I. Pigment Red -5, -7, -12, -48, -48:1, -57, -112, -122, -123, -146, -168, -177, -184, -202, and C.I. Pigment Violet-19.

Specific examples of black pigment include carbon black pigments. An example of an organic black pigment includes aniline black, such as C.I. Pigment Black 1.

Specific examples of a yellow pigment may include C.I. Pigment Yellow -1, -2, -3, -12, -13, -14, -16, -17, -73, -74, -75, -83, -93, -95, -97, -98, -114, -128, -129, -138, -151, -154, and -180.

While several examples have been given herein, it is to be understood that any other pigment or dye can be used that is useful in modifying the color of the inkjet ink 14.

As noted, the pigment may initially be present in a water-based dispersion. The pigment dispersion may then be incorporated into the ink vehicle so that the pigment is present in an active amount that is suitable for the inkjet printing architecture that is to be used. In an example, the pigment dispersion is incorporated into the ink vehicle so that the pigment is present in an amount ranging from about 0.5 wt % active to about 5 wt % active, based on a total weight of the inkjet ink 14. In other examples, the pigment dispersion is incorporated into the ink vehicle so that the pigment is present in an amount ranging from about 5 wt % active to about 10 wt % active, or from about 11 wt % active to about 15 wt % active, based on a total weight of the inkjet ink 14. In still another example, the pigment dispersion is incorporated into the ink vehicle so that the pigment is present in an amount of about 4 wt % active or about 6 wt % active, based on a total weight of the inkjet ink 14.

The inkjet ink also includes an ink aqueous vehicle. As used herein, the term “ink aqueous vehicle” may refer to the liquid with which the self-crosslinked polyurethane binder particle (dispersion) and the pigment (dispersion) are mixed to form a thermal or a piezoelectric inkjet ink composition. A wide variety of vehicles may be used with the ink composition(s) of the present disclosure. The ink aqueous vehicle may include water and any of: a co-solvent, a surfactant, an anti-kogation agent, an anti-decel agent, an antimicrobial agent, a rheology modifier, a pH adjuster, or combinations thereof. In an example of the inkjet ink 14, the ink aqueous vehicle consists of water. In another example, the vehicle consists of water and the co-solvent, the anti-kogation agent, the anti-decel agent, the surfactant, the antimicrobial agent, a rheology modifier, a pH adjuster, or a combination thereof. In still another example, the ink aqueous vehicle consists of water or water, a co-solvent, and an additive selected from the group consisting of a surfactant, an anti-kogation agent, an anti-decel agent, an antimicrobial agent, and combinations thereof. In an example, the ink aqueous vehicle is present in an amount of at least 30 wt % based on a total weight of the inkjet ink 14.

The co-solvent, when included in the vehicle of the inkjet ink 14, may be a water soluble or water miscible co-solvent. Examples of co-solvents include alcohols, amides, esters, ketones, lactones, and ethers. In additional detail, the co-solvent may include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers (e.g., Dowanol™ TPM (from Dow Chemical), higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples of alcohols may include ethanol, isopropyl alcohol, butyl alcohol, and benzyl alcohol. Other specific examples include 2-ethyl-2-(hydroxymethyl)-1,3-propane diol (EPHD), dimethyl sulfoxide, sulfolane, and/or alkyldiols such as 1,2-hexanediol.

The co-solvent may also be a polyhydric alcohol or a polyhydric alcohol derivative. Examples of polyhydric alcohols may include ethylene glycol, diethylene glycol, propylene glycol, butylene glycol, triethylene glycol, 1,5-pentanediol, 1,2-hexanediol, 1,2,6-hexanetriol, glycerin, trimethylolpropane, and xylitol. Examples of polyhydric alcohol derivatives may include an ethylene oxide adduct of diglycerin.

The co-solvent may also be a nitrogen-containing solvent. Examples of nitrogen-containing solvents may include 2-pyrrolidone, 1-(2-hydroxyethyl)-2-pyrrolidone, N-methyl-2-pyrrolidone, cyclohexylpyrrolidone, and triethanolamine.

The co-solvent(s), when included, may be present in the inkjet ink 14 in an amount ranging from about 0.1 wt % to about 60 wt % (based on the total weight of the inkjet ink 14). In some examples, the co-solvent(s) may range from about 1 wt % to about 30 wt % based on the total weight of the inkjet ink 14. In another example, the co-solvent(s) may range from about 5 wt % to about 20 wt % based on the total weight of the inkjet ink 14. In an example, the total amount of co-solvent(s) present in the inkjet ink 14 is about 10 wt % (based on the total weight of the inkjet ink 14).

The surfactant, when included in the vehicle of the inkjet ink 14, may be any non-ionic surfactant or anionic surfactant.

Examples of the non-ionic surfactant may include polyoxyethylene alkyl ether, polyoxyethylene alkyl phenyl ether, polyoxyethylene fatty acid ester, sorbitan fatty acid ester, polyoxyethylene sorbitan fatty acid ester, polyoxyethylene sorbitol fatty acid ester, glycerin fatty acid ester, polyoxyethylene glycerin fatty acid ester, polyglycerin fatty acid ester, polyoxyethylene alkylamine, polyoxyethylene fatty acid amide, alkylalkanolamide, polyethylene glycol polypropylene glycol block copolymer, acetylene glycol, and a polyoxyethylene adduct of acetylene glycol. Specific examples of the non-ionic surfactant may include polyoxyethylenenonyl phenylether, polyoxyethyleneoctyl phenylether, and polyoxyethylenedodecyl. Further examples of the non-ionic surfactant may include silicon surfactants such as a polysiloxane oxyethylene adduct; fluorine surfactants such as perfluoroalkylcarboxylate, perfluoroalkyl sulfonate, and oxyethyleneperfluoro alkylether; and biosurfactants such as spiculisporic acid, rhamnolipid, and lysolecithin.

More specific examples of non-ionic surfactant include a silicone-free alkoxylated alcohol surfactant such as, for example, TEGO® Wet 510 (Evonik Degussa) and/or a self-emulsifiable wetting agent based on acetylenic diol chemistry, such as, for example, SURFYNOL® SE-F (Evonik Degussa). Other suitable commercially available non-ionic surfactants include SURFYNOL® 465 (ethoxylatedacetylenic diol), SURFYNOL® 440 (an ethoxylated low-foam wetting agent) SURFYNOL® CT-211 (now CARBOWET® GA-211, non-ionic, alkylphenylethoxylate and solvent free), and SURFYNOL® 104 (non-ionic wetting agent based on acetylenic diol chemistry), (all of which are from Evonik Degussa); ZONYL® FSO (a.k.a. CAPSTONE®, which is a water-soluble, ethoxylated non-ionic fluorosurfactant from DuPont); TERGITOL® TMN-3 and TERGITOL® TMN-6 (both of which are branched secondary alcohol ethoxylate, non-ionic surfactants), and TERGITOL® 15-S-3, TERGITOL® 15-S-5, and TERGITOL® 15-S-7 (each of which is a secondary alcohol ethoxylate, non-ionic surfactant) (all of the TERGITOL® surfactants are available from The Dow Chemical Company); and BYK® 345, BYK® 346, BYK® 347, BYK® 348, BYK® 349 (each of which is a silicone surfactant) (all of which are available from BYK Additives and Instruments).

Examples of the anionic surfactant may include alkylbenzene sulfonate, alkylphenyl sulfonate, alkylnaphthalene sulfonate, higher fatty acid salt, sulfate ester salt of higher fatty acid ester, sulfonate of higher fatty acid ester, sulfate ester salt and sulfonate of higher alcohol ether, higher alkyl sulfosuccinate, polyoxyethylene alkylether carboxylate, polyoxyethylene alkylether sulfate, alkyl phosphate, and polyoxyethylene alkyl ether phosphate. Specific examples of the anionic surfactant may include dodecylbenzenesulfonate, isopropylnaphthalenesulfonate, monobutylphenylphenol monosulfonate, monobutylbiphenyl sulfonate, monobutylbiphenylsulfonate, and dibutylphenylphenol disulfonate. Examples of the non-ionic surfactant may include polyoxyethylene alkyl ether, polyoxyethylene alkyl phenyl ether, polyoxyethylene fatty acid ester, sorbitan fatty acid ester, polyoxyethylene sorbitan fatty acid ester, polyoxyethylene sorbitol fatty acid ester, glycerin fatty acid ester, polyoxyethylene glycerin fatty acid ester, polyglycerin fatty acid ester, polyoxyethylene alkylamine, polyoxyethylene fatty acid amide, alkylalkanolamide, polyethylene glycol polypropylene glycol block copolymer, acetylene glycol, and a polyoxyethylene adduct of acetylene glycol. Specific examples of the non-ionic surfactant may include polyoxyethylenenonyl phenylether, polyoxyethyleneoctyl phenylether, and polyoxyethylenedodecyl. Further examples of the non-ionic surfactant may include silicon surfactants such as a polysiloxane oxyethylene adduct; fluorine surfactants such as perfluoroalkylcarboxylate, perfluoroalkyl sulfonate, and oxyethyleneperfluoro alkylether; and biosurfactants such as spiculisporic acid, rhamnolipid, and lysolecithin.

In any of the examples disclosed herein, the surfactant may be present in the inkjet ink 14 in an amount ranging from about 0.01 wt % active to about 5 wt % active (based on the total weight of the inkjet ink 14). In an example, the surfactant is present in the inkjet ink 14 in an amount ranging from about 0.05 wt % active to about 3 wt % active, based on the total weight of the inkjet ink 14. In another example, the surfactant is present in the inkjet ink 14 in an amount of about 0.3 wt % active, based on the total weight of the inkjet ink 14.

An anti-kogation agent may also be included in the inkjet ink 14. Kogation refers to the deposit of dried printing liquid on a heating element of a thermal inkjet printhead. Anti-kogation agent(s) is/are included to assist in preventing the buildup of kogation. In some examples, the anti-kogation agent may improve the jettability of the inkjet ink 14. The anti-kogation agent(s) may be present in the inkjet ink 14 in a total amount ranging from about 0.1 wt % active to about 1.5 wt % active, based on the total weight of the inkjet ink 14. In an example, the anti-kogation agent(s) is/are present in an amount of about 0.5 wt % active, based on the total weight of the inkjet ink 14.

Examples of suitable anti-kogation agents include oleth-3-phosphate (commercially available as CRODAFOS™ O3A or CRODAFOS™ N-3A), oleth-5-phosphate (commercially available as CRODAFOS™ O5A), or dextran 500 k. Other suitable examples of the anti-kogation agents include CRODAFOS™ HCE (phosphate-ester from Croda Int.), CRODAFOS™ CES (phosphate-based emulsifying and conditioning wax from Croda Int.), CRODAFOS® N10 (oleth-10-phosphate from Croda Int.), or DISPERSOGEN® LFH (polymeric dispersing agent with aromatic anchoring groups, acid form, anionic, from Clariant), etc. It is to be understood that any combination of the anti-kogation agents listed may be used.

The inkjet ink 14 may also include anti-decel agent(s). The anti-decel agent may function as a humectant. Decel refers to a decrease in drop velocity over time with continuous firing. In the examples disclosed herein, the anti-decel agent(s) is/are included to assist in preventing decel. In some examples, the anti-decel agent may improve the jettability of the inkjet ink 14. An example of a suitable anti-decel agent is ethoxylated glycerin having the following formula:

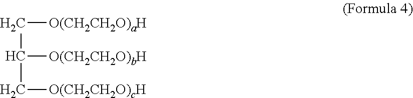

in which the total of a+b+c ranges from about 5 to about 60, or in other examples, from about 20 to about 30. An example of the ethoxylated glycerin is LIPONIC® EG-1 (LEG-1, glycereth-26, a+b+c=26, available from Lipo Chemicals).

The anti-decel agent(s) may be present in an amount ranging from about 0.2 wt % active to about 5 wt % active (based on the total weight of the inkjet ink 14). In an example, the anti-decel agent is present in the inkjet ink 14 in an amount of about 1 wt % active, based on the total weight of the inkjet ink 14.

The vehicle of the inkjet ink 14 may also include antimicrobial agent(s). Antimicrobial agents are also known as biocides and/or fungicides. Examples of suitable antimicrobial agents include the NUOSEPT® (Ashland Inc.), UCARCIDE™ or KORDEK™ or ROCIMA™ (Dow Chemical Co.), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof.

In an example, the total amount of antimicrobial agent(s) in the inkjet ink 14 ranges from about 0.01 wt % active to about 0.05 wt % active (based on the total weight of the inkjet ink 14). In another example, the total amount of antimicrobial agent(s) in the inkjet ink 14 is about 0.044 wt % active (based on the total weight of the inkjet ink 14).

The ink vehicle may also include rheology additive(s). The rheology additive may be added to adjust the viscosity of the inkjet ink 14 and to aid in redispersibility of the inkjet ink after it has sat idle. Examples of suitable rheology additives include boehmite, laponite, anionic cellulose (e.g., carboxymethyl cellulose, cellulose sulfate, nitrocellulose, and combinations thereof), and combinations thereof.

In an example, the total amount of rheology additive(s) in the inkjet ink 14 ranges from about 0.005 wt % active to about 5 wt % active (based on the total weight of the inkjet ink 14).

The ink vehicle may also include pH adjuster(s). The type and amount of pH adjuster that is added may depend upon the initial pH of the inkjet ink 14 and the desired final pH of the inkjet ink 14. If the initial pH is too high, an acid may be added to lower the pH, and if the initial pH is too low, a base may be added increase the pH. Examples of suitable pH adjusters include metal hydroxide bases, such as potassium hydroxide (KOH), sodium hydroxide (NaOH), etc. In an example, the metal hydroxide base may be added to the inkjet ink 14 in an aqueous solution. In another example, the metal hydroxide base may be added to the inkjet ink 14 in an aqueous solution including 5 wt % of the metal hydroxide base (e.g., a 5 wt % potassium hydroxide aqueous solution). Any of the acidic pH adjusters mentioned herein may also be used.

In an example, the total amount of pH adjuster(s) in the inkjet ink 14 ranges from greater than 0 wt % to about 0.1 wt % (based on the total weight of the inkjet ink 14). In another example, the total amount of pH adjuster(s) in the inkjet ink 14 is about 0.03 wt % (based on the total weight of the inkjet ink 14).

The balance of the inkjet ink 14 is water. As such, the weight percentage of the water present in the inkjet ink 14 will depend, in part, upon the weight percentages of the other components. The water may be purified water or deionized water.

The inkjet ink 14 may have a total solids content ranging from about 0.6% to about 31%.

### Fixer Fluid

The fixer fluid 12 includes an azetidinium-containing polyamine and a fixer aqueous vehicle. In one example, the fixer fluid 12 described herein includes an azetidinium-containing polyamine; a phosphate ester surfactant; a co-solvent containing two hydroxyl groups and an aliphatic chain between the two hydroxyl groups, the aliphatic chain containing three carbon atoms; and a balance of water. In some examples, the fixer fluid 12 consists of the polyamine, the phosphate ester surfactant, the fixer fluid co-solvent, and the balance of water; and thus does not include any other components. In other examples, the azetidinium-containing polyamine further comprises a pH adjuster. In still other examples, the azetidinium-containing polyamine may further include an additional non-ionic surfactant.

The azetidinium-containing polyamine can include any number of azetidinium groups. In an uncrosslinked state, an azetidinium group generally has a structures as follows:

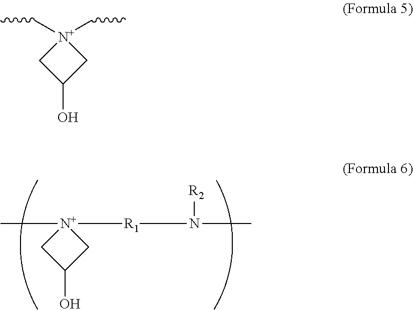

where R₁ can be a substituted or unsubstituted C₂-C₁₂ linear alkyl group and R₂ is H or CH₃. In some additional examples, R₁ can be a C₂-C₁₀, C₂-C₈, or C₂-C₆ linear alkyl group. More generally, there may be from 2 to 12 carbon atoms between amine groups (including azetidinium groups) in the azetidinium-containing polyamine. In other examples, there can be from 2 to 10, from 2 to 8, or from 2 to 6 carbon atoms between amine groups in the azetidinium-containing polyamine. In some examples, where R₁ is a C₃-C₁₂ (or C₃-C₁₀, C₃-C₈, C₃-C₆, etc.) linear alkyl group, a carbon atom along the alkyl chain can be a carbonyl carbon, with the proviso that the carbonyl carbon does not form part of an amide group (i.e., R₁ does not include or form part of an amide group). In some additional examples, a carbon atom of R₁ can include a pendent hydroxyl group.

In some examples, the azetidinium-containing polyamine can be derived from the reaction of a polyalkylene polyamine (e.g., ethylenediamine, bishexamethylenetriamine, hexamethylenediamine, etc.) with an epihalohydrin (e.g., epichlorohydrin). More particularly, the polyalkylene polyamine reacts with the epihalohydrin to form an epoxide-containing polyamine, which then rearranges by itself to form Formula 5 or 6. These azetidinium-containing polyamines are often referred to as PAmE resins.

As can be seen in Formula 6, the azetidinium-containing polyamine can include a quaternary amine (e.g., the azetidinium group) and a non-quaternary amine (e.g., a primary amine, a secondary amine, a tertiary amine, or a combination thereof). In some specific examples, the azetidinium-containing polyamine can include a quaternary amine and a tertiary amine. In some additional examples, the azetidinium-containing polyamine can include a quaternary amine and a secondary amine. In some further examples, the azetidinium-containing polyamine can include a quaternary amine and a primary amine. The azetidinium-containing polyamine can have a ratio of azetidinium groups to other amine groups ranging from 0.1:1 to 10:1. In other examples, the azetidinium-containing polyamine can have a ratio of azetidinium groups to other amine groups ranging from 0.5:1 to 2:1. Some examples of commercially available azetidinium-containing polyamines that fall within these ranges of azetidinium group to amine groups include CREPETROL™ 73, KYMENE™ 736, KYMENE™ 736NA, POLYCUP™ 7360, and POLYCUP™ 7360A, each of which is available from Solenis LLC.

When the fixer fluid 12 is printed, the azetidinium group of the fixer fluid 12 can interact or react with suitable reactive groups that may be present in the backbone of the polyurethane polymer in the inkjet ink 14 (which is printed on the fixer fluid 12). The azetidinium-containing polyamine contains the cationic species. The cationic species of the polyamine may react with the hydroxide (—OH) group of the sulfonate group (sulfonic acid) or the carboxylate group (carboxylic group) on the backbone of the polyurethane polymer particle to open the 4-membered ring adduct of the polyamine.

The reactions or interactions of the side chain groups (e.g., the sulfonate groups or the carboxylate groups) on the polyurethane polymer particles of the inkjet ink 14 and azetidinium-containing polyamine groups of the fixer fluid 12 may lead to enhanced durability of a printed image due to the crosslinking.

In some instances, the azetidinium group of the fixer fluid 12 may react or interact with hydroxyl groups (e.g., for cotton), amine groups (e.g., for nylon), thiol groups (e.g., for wool), or other suitable reactive groups that may be present at the surface of the textile fabric 16.

The interaction between the azetidinium group in the fixer fluid 12 and the groups in the inkjet ink 14 and/or the groups at the surface of the textile fabric 16 generate a high quality image that exhibits durability and wet-crock-fastness.

Some example reactions between the azetidinium group and various reactive groups (of the polyurethane polymer (Schemes I and II) and/or of the textile fabric (Schemes I-V)) are illustrated below in Schemes I-V, as follows:

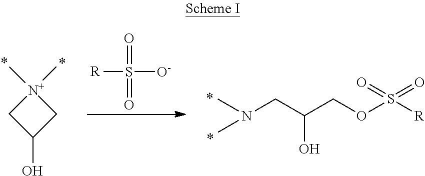

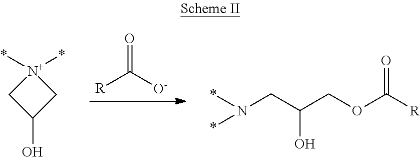

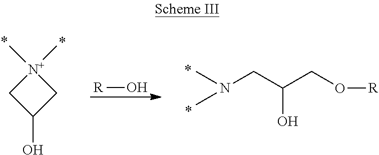

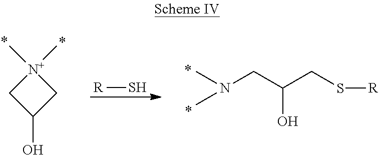

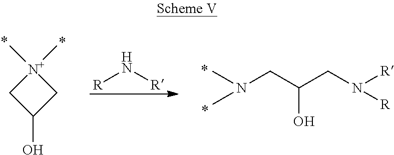

In Schemes II-V, the asterisks (*) represent portions of the various organic compounds (e.g., a substituted or unsubstituted C₂-C₁₂ linear alkyl group) that may not be directly part of the reaction shown in Schemes I-V, and are thus not shown, but could be any of a number of organic groups or functional moieties, for example. Likewise, R and R′ can be H or any of a number of organic groups, such as those described previously in connection with R1 or R2 in Formulas 5 and 6, without limitation.

In further detail, in accordance with examples shown, the azetidinium groups present in the fixer fluid 12 can interact with the polyurethane polymer, the textile fabric 16, or both to form a covalent linkage therewith, as shown in Schemes I-V above. Other types of reactions can also occur, but Schemes I-V are provided by way of example to illustrate examples of reactions that can occur when the inkjet ink 14, the textile fabric 16, or both come into contact with the fixer fluid 12. Examples of other types of interactions or reactions may include, for example, interaction or reaction with the textile fabric 16, interaction or reaction between different types of moieties on the polyurethane polymer backbone, interactions or reactions with different molar ratios (other than 1:1, for example) than that shown in Schemes I-V, etc.

In an example, the azetidinium-containing polyamine is present in an amount ranging from about 0.5 wt % active to about 12 wt % active based on a total weight of the fixer fluid 12. In further examples, the azetidinium-containing polyamine is present in an amount ranging from about 1 wt % active to about 10 wt % active; or from about 2 wt % active to about 8 wt % active; or from about 4 wt % active to about 6.5 wt % active, based on a total weight of the fixer fluid 12.

The fixer fluid 12 also includes a phosphate ester surfactant. The phosphate ester surfactant has the formula:

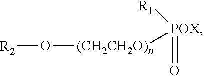

wherein: R₁ is —OX or R₂—O—(CH₂CH₂O)ₙ—; R₂ is an alkyl group, alkenyl group, or alkylphenyl group having from 8 to 18 carbon atoms; X is a hydrogen, alkali metal, amine, or alkanolamine; and n is an integer ranging from 1 to 18. When R₂ is an alkenyl group having from 8 to 18 carbon atoms, it is to be understood that R₂ is a C₈ to C₁₈ alkyl chain that includes one or more alkenyl groups in the chain. Similarly, when R₂ is an alkylphenyl group having from 8 to 18 carbon atoms, it is to be understood that R₂ is a C₈ to C₁₈ alkyl chain that includes one or more alkylphenyl groups as a pendant group attached to the chain. Some examples of commercially available phosphate ester surfactants include CRODAFOS™ O3A (formerly CRODAFOS™ N3A; a phosphate ester based on tridecyl alcohol), CRODAFOS™ O10A (formerly CRODAFOS™ N10A or CRODAFOS™ N10 Acid; a complex ester of phosphoric acid and ethoxylated oleyl alcohol), and CRODAFOS™ HCE (oleth-5-phosphate and dioleyl phosphate), each of which is available from Croda Int.

While phosphate ester surfactants are often used as anti-kogation agents, the examples set forth herein demonstrate that the combination of the phosphate ester surfactant with the specific fixer fluid co-solvent(s) has a synergistic effect on the kogation reduction.

In an example, the phosphate ester surfactant is present in an amount ranging from about 0.1 wt % active to about 5 wt % active based on a total weight of the fixer composition. In further examples, the phosphate ester surfactant is present in an amount ranging from about 0.5 wt % active to about 3 wt % active; or from about 0.75 wt % active to about 1.5 wt % active; or from about 0.2 wt % active to about 1 wt % active, based on a total weight of the fixer composition.

The fixer fluid co-solvent contains two hydroxyl groups and an aliphatic chain between the two hydroxyl groups, the aliphatic chain containing three carbon atoms. In one example, the aliphatic chain is not substituted. In this example, the co-solvent is 1,3-propanediol, having the following structure.

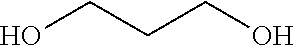

In other examples, the aliphatic chain is substituted, for example, with one or more methyl groups. Examples of the co-solvent with one methyl group include 1,3-butanediol, having the following structure:

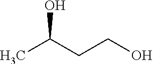

or 2-methyl-1,3-propanediol, having the structure:

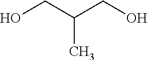

Examples of the fixer fluid co-solvent with two or more methyl group include 2,2-dimethyl-1,3-propanediol, having the structure:

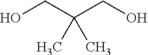

or hexylene glycol, having the following structure.

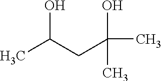

As shown in the examples disclosed herein, alcohols with additional hydroxide groups and/or with longer chain lengths do not lead to the synergistic effect of the co-solvents containing two hydroxyl groups and the C₃ aliphatic chain between the two hydroxyl groups.

In one example of the fixer fluid 12, the co-solvent is selected from the group consisting of 2-methyl-1,3-propanediol, 1,3-butanediol, 1,3-propanediol, hexylene glycol, 2,2-dimethyl-1,3-propanediol, and combinations thereof.

In an example, the fixer fluid co-solvent is present in an amount ranging from about 1 wt % to about 20 wt % based on a total weight of the fixer fluid 12. Whether used alone or in a combination, the total fixer fluid co-solvent amount is within this range. In further examples, the fixer fluid co-solvent is present in an amount ranging from about 2 wt % to about 15 wt %; or from about 2.5 wt % to about 10 wt %; or from about 3 wt % to about 8 wt %, based on a total weight of the fixer fluid 12.

In addition to the phosphate surfactant and the co-solvent(s), the fixer fluid 12 may further include additional fixer aqueous vehicle components. In some examples, the fixer aqueous vehicle component consists of water. In other examples, the fixer aqueous vehicle component includes additives, such as pH adjuster(s) and other surfactant(s). Each of these additives may each be present in an amount of about 0.1 wt % to about 5 wt % based on the total weight of the fixer fluid 12.

The pH adjuster(s) in the fixer fluid 12 may be any example of the pH adjusters set forth herein for the inkjet ink 14, in any amount set forth herein for the inkjet ink 14 (except that the amount(s) are based on the total weight of the fixer fluid 12 instead of the inkjet ink 14). The pH adjuster may be selected to render the fixer fluid 12 with an acidic pH.

The other surfactant(s) in the fixer fluid 12 may be any example of the non-ionic set forth herein for the inkjet ink 14, in any amount set forth herein for the inkjet ink 14 (except that the amount(s) are based on the total weight of the fixer fluid 12 instead of the inkjet ink 14).

In addition to the non-ionic surfactant or as an alternative to the non-ionic surfactant, the fixer fluid 12 may include a cationic surfactant. Examples of the cationic surfactant include quaternary ammonium salts, such as benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride, domiphen bromide, alkylbenzyldimethylammonium chlorides, distearyldimethylammonium chloride, diethyl ester dimethyl ammonium chloride, dipalmitoylethyl hydroxyethylmonium methosulfate, and ACCOSOFT® 808 (methyl (1) tallow amidoethyl (2) tallow imidazolinium methyl sulfate available from Stepan Company). Other examples of the cationic surfactant include amine oxides, such as lauryldimethylamine oxide, myristamine oxide, cocamine oxide, stearamine oxide, and cetamine oxide. The cationic surfactant may present in the amount set forth herein for the surfactant in the inkjet ink 14 (except that the amount(s) are based on the total weight of the fixer fluid 12 instead of the inkjet ink 14).

The balance of the fixer aqueous vehicle is water. As such, the weight percentage of the water present in the fixer fluid 12 will depend, in part, upon the weight percentages of the other components. The water may be purified water or deionized water.

### Textile Fabrics

In the examples disclosed herein, the textile fabric 16 (i.e., fabric substrate) may be selected from the group consisting of polyester fabrics, polyester blend fabrics, cotton fabrics, cotton blend fabrics, nylon fabrics, nylon blend fabrics, silk fabrics, silk blend fabrics, wool fabrics, wool blend fabrics, and combinations thereof. In a further example, the textile fabric 16 is selected from the group consisting of cotton fabrics and cotton blend fabrics.

It is to be understood that organic textile fabrics and/or inorganic textile fabrics may be used for the textile fabric 16. Some types of fabrics that can be used include various fabrics of natural and/or synthetic fibers. It is to be understood that the polyester fabrics may be a polyester coated surface. The polyester blend fabrics may be blends of polyester and other materials (e.g., cotton, linen, etc.). In another example, the textile fabric 16 may be selected from nylons (polyamides) or other synthetic fabrics.

Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources (e.g. cornstarch, tapioca products, sugarcanes), etc. Example synthetic fibers used in the textile fabric/substrate 18 can include polymeric fibers such as nylon fibers, polyvinyl chloride (PVC) fibers, PVC-free fibers made of polyester, polyamide, polyimide, polyacrylic, polypropylene, polyethylene, polyurethane, polystyrene, polyaramid (e.g., KEVLAR®) polytetrafluoroethylene (TEFLON®) (both trademarks of E.I. du Pont de Nemours and Company, Delaware), fiberglass, polytrimethylene, polycarbonate, polyethylene terephthalate, polyester terephthalate, polybutylene terephthalate, or a combination thereof. In an example, natural and synthetic fibers may be combined at ratios of 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both the polymeric fiber and a surface of the fabric, a plasma treatment, a solvent treatment, acid etching, or a biological treatment, an enzyme treatment, or antimicrobial treatment to prevent biological degradation.

In addition, the textile fabric 16 can contain additives, such as a colorant (e.g., pigments, dyes, and tints), an antistatic agent, a brightening agent, a nucleating agent, an antioxidant, a UV stabilizer, a filler, and/or a lubricant, for example.

It is to be understood that the terms “textile fabric” or “fabric substrate” do not include materials commonly known as any kind of paper (even though paper can include multiple types of natural and synthetic fibers or mixtures of both types of fibers). Fabric substrates 16 can include textiles in filament form, textiles in the form of fabric material, or textiles in the form of fabric that has been crafted into finished articles (e.g., clothing, blankets, tablecloths, napkins, towels, bedding material, curtains, carpet, handbags, shoes, banners, signs, flags, etc.). In some examples, the fabric substrate 16 can have a woven, knitted, non-woven, or tufted fabric structure. In an example, the textile fabric 16 is a woven or knitted fabric. In another example, the fabric substrate 16 can be a woven fabric where warp yarns and weft yarns can be mutually positioned at an angle of about 90°. This woven fabric can include fabric with a plain weave structure, fabric with twill weave structure where the twill weave produces diagonal lines on a face of the fabric, or a satin weave. In another example, the fabric substrate 16 can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate 16 can be a non-woven fabric. For example, the non-woven fabric can be a flexible fabric that can include a plurality of fibers or filaments that are one or both bonded together and interlocked together by a chemical treatment process (e.g., a solvent treatment), a mechanical treatment process (e.g., embossing), a thermal treatment process, or a combination of multiple processes.

In one example, the textile fabric 16 can have a basis weight ranging from 10 gsm to 500 gsm. In another example, the textile fabric 16 can have a basis weight ranging from 50 gsm to 400 gsm. In other examples, the textile fabric 16 can have a basis weight ranging from 100 gsm to 300 gsm, from 75 gsm to 250 gsm, from 125 gsm to 300 gsm, or from 150 gsm to 350 gsm.

The textile fabric 16 may be any color, and in an example is a color other than white (e.g., black, grey, etc.).

### Printing Method and System

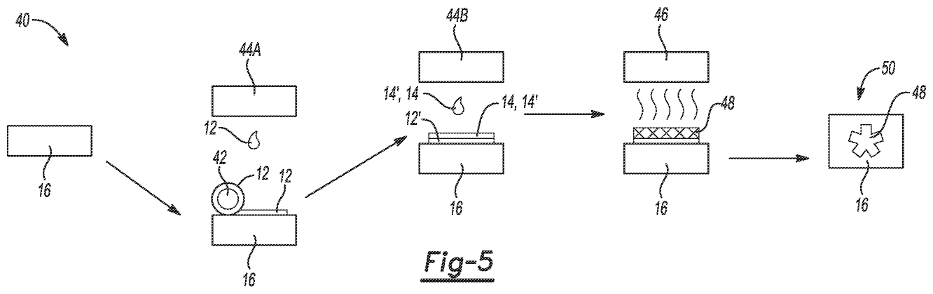

FIG. 4 depicts an example of the printing method 100, and FIG. 5 depicts an example of a system 40 for performing the printing method 100. As shown in FIG. 4, an example of the printing method 100 comprises: applying a fixer fluid 12 on at least a portion of the textile fabric 16 to generate a pre-treated portion 12′ (see FIG. 5) of the textile fabric 16, the fixer fluid 12 including: an azetidinium-containing polyamine; and a fixer aqueous vehicle (shown at reference numeral 102); and applying an inkjet ink 14 on at least a portion of the pre-treated portion 12′ of the textile fabric 16, the inkjet ink 14 including: a self-crosslinked polyurethane binder particle including a polyurethane polymer with a polymerized carboxylate-based diol and a sulfonated diamine; a pigment; and an ink aqueous vehicle (shown at reference numeral 104). An example of the method may further include exposing the textile fabric 16 having the printed image thereon to a thermal curing process (shown at reference numeral 106).

It is to be understood that any example of the fixer fluid 12 and the inkjet ink 14 may be used in the examples of the method 100. Furthermore, different colors of the inkjet inks 14, 14′ may be used together in the method 100. Still further, it is to be understood that any example of the textile fabric 16 may be used in the examples of the method 100.

As shown in reference numerals 102 and 104 in FIG. 4, the method 100 includes applying the fixer fluid 12 on the textile fabric 16 to form a pre-treated portion 12′ of the textile fabric 16.

The fixer fluid 12 is applied directly to the textile fabric 16. The application of the fixer fluid 12 may be accomplished via an analog method, or via a digital inkjet printing method.

As examples of analog methods, the fixer fluid 12 may be applied using an auto analog pretreater, a drawdown coater, a slot die coater, a roller coater, a fountain curtain coater, a blade coater, a rod coater, an air knife coater, a sprayer, a padder, or a gravure application. In these examples, the fixer fluid 12 may be coated on all or substantially all of the textile fabric 16. In these examples, the pre-treated portion 12′ may be a continuous layer that covers all or substantially all of the textile fabric 16

In some examples, the fixer fluid 12 may be applied via a digital inkjet printing method. As examples, the fixer fluid 12 may be applied using piezoelectric inkjet printing or thermal inkjet printing. Any suitable inkjet applicator, such as a thermal inkjet printhead, a piezoelectric printhead, a continuous inkjet printhead, etc. may be used. The fixer fluid 12 may be applied on all or substantially all of the textile fabric 16. In these examples, the pre-treated portion 12′ may be a continuous layer that covers all or substantially all of the textile fabric 16. In other examples when piezoelectric or thermal inkjet printing is used, the fixer fluid 12 may be applied on areas of the textile fabric 16 where it is desirable to form the printed image 48. In these examples, the pre-treated portion 12′ may be non-continuous (e.g., may contain gaps) because the fixer fluid 12 may not be printed on areas of the textile fabric 16 where it is not desirable to form the printed image 48.

In an example, the fixer fluid 12 is applied in an amount ranging from about 50 gsm (grams per square meter, when wet) to about 120 gsm. In another example, the fixer fluid 12 is applied in an amount ranging from about 85 gsm to about 100 gsm.

As shown in reference numeral 104 in FIG. 4, the method 100 also includes inkjet (e.g., thermal inkjet or piezoelectric inkjet) printing the inkjet ink 14 on the pre-treated portion 12′ (shown in FIG. 5). It is to be understood that the inkjet ink 14 is printed at desirable areas to form a printed image (e.g., print 48).

In an example, the inkjet ink 14 is applied in an amount ranging from about 200 gsm to about 400 gsm. In another example, the inkjet ink 14 is applied in an amount ranging from about 200 gsm to about 350 gsm.

In some examples, multiple inkjet inks 14, 14′ may be inkjet printed onto the textile fabric 16. In these examples, each of the inkjet inks 14, 14′ may include a pigment, an example of the polyurethane polymer, and the ink vehicle. Each of the inkjet inks 14, 14′ may include a different colored pigment so that a different color (e.g., cyan, magenta, yellow, black, violet, green, brown, orange, purple, etc.) is generated by each of the inkjet inks 14, 14′. In other examples (as shown in FIG. 5), a single inkjet ink 14 may be inkjet printed onto the textile fabric 16.

The fixer fluid 12 and the inkjet ink 14 are applied to the textile fabric 16. As an example, the fixer fluid 12 and the inkjet ink 14 are applied sequentially, using digital inkjet printing, one immediately after the other as the applicators 44A, 44B (e.g., cartridges, pens, printheads, etc.) pass over the textile fabric 16. As such, the inkjet ink 14 is printed onto the pre-treated portion 12′ while the fixer fluid 12 at the portion 12′ is wet. Wet-on-wet printing may be desirable because less fixer fluid 12 may be applied during this process (as compared to if the fixer fluid 12 were to be dried prior to inkjet ink 14 application), and because the printing workflow may be simplified without the additional drying. Wet-on-wet printing may also be desirable because the interaction between the azetidinium-containing polyamine in the fixer fluid 12 and the polyurethane polymer in the inkjet ink 14 during subsequent thermal curing is believed to lead to enhanced wet crock-fastness. In an example of wet-on-wet printing, the inkjet ink 14 is printed onto the pre-treated portion 12′ within a period of time ranging from about 0.01 second to about 30 seconds after the fixer fluid 12 is printed. In further examples, the inkjet ink 14 is printed onto the pre-treated portion 12′ within a period of time ranging from about 0.1 second to about 20 seconds; or from about 0.2 second to about 10 seconds; or from about 0.2 second to about 5 seconds after the fixer fluid 12 is applied. Wet-on-wet printing may be accomplished in a single pass.

The inkjet printing of the fixer fluid 12 and the inkjet ink 14 may be accomplished at high printing speeds. In an example, the inkjet printing of the fixer fluid 12 and the inkjet ink 14 may be accomplished at a printing speed of at least 25 feet per minute (fpm). In another example, the fixer fluid 12 and the inkjet ink 14 may be inkjet printed at a printing speed ranging from 100 fpm to 1000 fpm.

As shown in reference numeral 106 in FIG. 4, the method 100 includes exposing the textile fabric 16 (with the pre-treated portion 12′ and the inkjet ink 14 thereon) to a thermal curing process. The thermal curing may be accomplished by applying heat to the textile fabric 16. In an example, the thermal curing process is performed at a temperature ranging from about 80° C. and 150° C. using heating mechanism 46 (shown in FIG. 5). In an example of the method 100, the thermal curing involves heating the textile fabric 16 (having the printed image 48 thereon) to a temperature ranging from about 80° C. to about 150° C., for a period of time ranging from about 10 seconds to about 15 minutes. In another example, the temperature ranges from about 100° C. to about 125° C. In still another example, thermal curing is achieved by heating the textile fabric 16 to a temperature of 130° C. for about 3 minutes.

Pressure may also be applied during thermal curing. The pressure applied to the textile fabric 16 (with the pre-treated portion 12′ and the ink 14 thereon) ranges from about 0.1 atm to about 8 atm.

Referring now to FIG. 5, a schematic diagram of a printing system 40 is depicted.

In one example, the textile fabric/substrate 16 may be transported through the printing system 40. The textile fabric 16 then has an example of the fixer fluid 12 applied thereon. The fixer fluid 12 may be applied using an analog applicator 42 (e.g., an auto analog pretreater, a drawdown coater, a slot die coater, a roller coater, a fountain curtain coater, a blade coater, a rod coater, an air knife coater, a sprayer, or a gravure application) or using a digital printhead 44A.

The textile fabric 16 (having the wet pre-treated portion 12′ thereon) then has an example of an inkjet ink 14 (or several inkjet inks 14, 14′) applied to at least a portion of the pre-treated portion 12′. The inkjet ink 14 is applied using a digital printhead 44B. The system 40 may include multiple digital printheads 44B for dispensing different inkjet inks 14, 14′.

The textile fabric 16 (having the pre-treated portion 12′ and the ink 14 thereon) may then be thermally cured. During thermal curing, pre-treated portion 12′ and the ink 14 are heated to cure the layers and form the printed image 48. Heating may be performed using any suitable heating mechanism 46, such as a heat press, oven, etc. Heating crosslinks the reactive groups of the polyamide at the pre-treated portion 12′ with reactive groups in the textile fabric 16 and/or in the ink 14. The heat generated is also sufficient to initiate crosslinking or other interactions that bind the pigment onto an example of the textile fabric 16, such as cotton. In some examples, the heat generated initiates interactions, such as adhesion forces, to adhere the pigment onto an example of the textile fabric 16, such as polyester. The heat to initiate fixation (thermal curing) may range from about 80° C. to 150° C. as described above. This process forms the printed article 50 including the image 48 formed on the textile fabric 16.

To further illustrate the present disclosure, an example is given herein. It is to be understood that this example is provided for illustrative purposes and is not to be construed as limiting the scope of the present disclosure.

### EXAMPLE

### Example 1

An example magenta ink (Ex. M1) including the sulfonated and carboxylated polyurethane binder particles disclosed herein was prepared. The sulfonated and carboxylated polyurethane had an acid number of 9.6.

The example sulfonated and carboxylated polyurethane (Ex. SCPU) of Ex. M1 was prepared as follows:

72.468 g of polyester polyol (STEPANOL® PC-1015-55), 0.21 g of 2,2-bis(hydroxymethyl) propionic acid (i.e., Dimethylolpropionic Acid (DMPA)) and 20.570 g of isophorone diisocyanate (IPDI) in 80 g of acetone were mixed in a 500 ml of 4-neck round bottom flask. A mechanical stirrer with glass rod and TEFLON® blade was attached. A condenser was also attached. The flask was immersed in a constant temperature bath at 75° C. The system was kept under a drying tube. 3 drops of dibutyltin dilaurate (DBTDL) were added to initiate the polymerization. Polymerization was continued for 6 hours at 75° C. 0.5 g samples were withdrawn for % NCO titration to confirm the reaction. The measured NCO value was 4.98% (theoretical % NCO should be 4.98%). This formed the pre-polymer solution. The polymerization temperature was reduced to 50° C. 3.822 g of 2,2,4-trimethylhexane-1,6-diamine (TMD), 0.131 g of 50% sodium hydroxide aqueous solution, 5.945 g of sodium aminoalklysulphonate (A-95, 50% in water) and 14.863 g of deionized water are mixed in a beaker until TMD and A-95 were completely dissolved. The TMD and A-95 solution was added to the pre-polymer solution at 50° C. with vigorous stirring over 5 minutes. The solution became viscous and slight hazy. The mixture was stirred for 30 minutes at 50° C. Then, 201.432 g of cold deionized water was added to the polymer mixture in 4-neck round bottom flask over 10 minutes with good agitation to form the example polyurethane binder dispersion. The agitation was continued for 60 minutes at 50° C. The example polyurethane binder dispersion was filtered through 400 mesh stainless sieve. Acetone was removed with rotorvap at 50° C. (2 drops (20 mg) of BYK-011 de-foaming agent were added). The final polyurethane binder dispersion was filtered through fiber glass filter paper. The particle size measured by Malvern Zetasizer was 108.7 nm. The pH was 7.5. The solid content was 32.84%.

A comparative example magenta ink (Comp. M2) including sulfonated and carboxylated polyurethane binder particles was also prepared. This sulfonated and carboxylated polyurethane had an acid number of 16.4 due to a higher number of carboxylic acid groups.

The comparative sulfonated and carboxylated polyurethane (Comp. SCPU) of Comp. M2 was prepared as follows:

71.273 g of polyester polyol (STEPANOL® PC-1015-55), 1.856 g of 2,2-bis(hydroxymethyl) propionic acid (i.e., Dimethylolpropionic Acid (DMPA)) and 20.189 g of isophorone diisocyanate (IPDI) in 80 g of acetone were mixed in a 500 ml of 4-neck round bottom flask. A mechanical stirrer with glass rod and TEFLON® blade was attached. A condenser was also attached. The flask was immersed in a constant temperature bath at 75° C. The system was kept under a drying tube. 3 drops of dibutyltin dilaurate (DBTDL) were added to initiate the polymerization. Polymerization was continued for 6 hours at 75° C. 0.5 g samples were withdrawn for % NCO titration to confirm the reaction. The measured NCO value was 3.79% (theoretical % NCO should be 3.79%). This formed the pre-polymer solution. The polymerization temperature was reduced to 50° C. 3.759 g of 2,2,4-trimethylhexane-1,6-diamine (TMD), 1.162 g of 50% sodium hydroxide aqueous solution, 5.847 g of sodium aminoalklysulphonate (A-95, 50% in water) and 14.618 g of deionized water were mixed in a beaker until TMD and A-95 were completely dissolved. The TMD and A-95 solution was added to the pre-polymer solution at 50° C. with vigorous stirring over 5 minutes. The solution became viscous and slight hazy. The mixture was stirred for 30 minutes at 50° C. Then, 201.506 g of cold deionized water was added to polymer mixture in 4-neck round bottom flask over 10 minutes with good agitation to form the comparative polyurethane binder dispersion. The agitation was continued for 60 minutes at 50° C. The comparative polyurethane binder dispersion was filtered through 400 mesh stainless sieve. Acetone was removed with rotorvap at 50° C. (2 drops (20 mg) of BYK-011 de-foaming agent were added). The final comparative polyurethane binder dispersion was filtered through fiber glass filter paper. The particle size measured by Malvern Zetasizer was 1115.3 nm. The pH was 7. The solid content was 21.41%.

Another comparative example magenta ink (Comp. M3) was prepared with a comparative polyurethane, namely an anionic aliphatic polyester-polyurethane binder (IMPRANIL® DLN-SD (Acid Number 5.2) from Covestro).

The magenta ink formulations are shown in Table 1.

TABLE 1
Magenta Inks

| | | Ex. M1 | Comp. M2 | Comp. M3 |
|---|---|---|---|---|
| | | (wt % | (wt % | (wt % |
| Ingredient | Specific Component | active) | active) | active) |
| Pigment | Magenta pigment | 3 | 3 | 3 |
| dispersion | dispersion available | | | |
| | from DIC | | | |
| Binder | Ex. SCPU | 6 | 0 | 0 |
| | Comp. SCPU | 0 | 6 | 0 |
| | IMPRANIL ® | 0 | 0 | 6 |
| | DLN-SD | | | |
| Co-solvent | Glycerol | 6 | 6 | 6 |
| Anti-decel | LIPONIC ® EG-1 | 1 | 1 | 1 |
| agent | | | | |
| Anti-kogation | CRODAFOS ™ | 0.5 | 0.5 | 0.5 |
| agent | N-3A | | | |
| Surfactant | SURFYNOL ® 440 | 0.3 | 0.3 | 0.3 |
| Antimicrobial | ACTICIDE ® B20 | 0.044 | 0.044 | 0.044 |
| agent | | | | |
| Water | Deionized water | Balance | Balance | Balance |

The jettability performance of each of the example and comparative example magenta inks was tested. The magenta inks were printed using a thermal inkjet printer. The jettability performance was evaluated for decap, missing nozzles, drop weight, drop velocity, decel performance.

The term “decap performance,” as referred to herein, means the ability of the ink to readily eject from the printhead, upon prolonged exposure to air. The decap time is measured as the amount of time that a printhead may be left uncapped (i.e., exposed to air) before the printer nozzles no longer fire properly, potentially because of clogging, plugging, or retraction of the colorant from the drop forming region of the nozzle/firing chamber. To test the decap performance, a reference line of the ink was printed from a printhead that was not uncapped (i.e., was not exposed to air). Then, the printhead was filled with the ink and left uncapped (i.e., exposed to air) for a predetermined amount of time (e.g., 7 seconds) before the ink was ejected again from the printhead. A score was then assigned to the ink based on the number of spits performed before a line with the same print quality as the reference line was printed. A lower decap score indicates higher quality firing of the nozzles and less clogging, plugging, or retraction of the colorant from the drop forming region of the nozzle/firing chamber. A decap score higher than 15 (>15) indicates that a good line was not obtained after 15 spits. The results of the decap performance tests for each magenta ink is shown in Table 2.

For the missing nozzles test, a test print was printed to make sure all of the nozzles of the printer were firing properly, which was followed by a diagnostic pattern showing the health of each nozzle. The nozzles remained unfired for about 1 second, and then the diagnostic pattern was printed again. The percentage of missing nozzles after the idle time was recorded, and the results are shown in Table 2.

Both the drop weight and the drop velocity of the magenta inks were monitored. The average drop weight of 2,000 drops fired at a firing frequency of 30 KHz was calculated.

The term “decel,” as referred to herein, refers to a decrease in the drop velocity over time (e.g., 6 seconds) of droplets fired from an inkjet printhead. A large decrease in drop velocity (e.g., a decrease in drop velocity of greater than 0.5 m/s) can lead to poor image quality, which can be observed, for example, by the color difference between the print samples from continuously firing nozzles and the print samples from non-continuously firing nozzles. In contrast, fluids that do not experience decel (i.e., no decrease in drop velocity) or experience an acceptable decel (e.g., a decrease in drop velocity of 0.5 m/s or less) will continue to generate quality printed images. In order to determine decel performance, each of the example and comparative example magenta inks was filled into a thermal inkjet print head and the drop velocity vs. firing time over 6 seconds was collected. The results of the decel performance test for each magenta ink is shown in Table 2.

TABLE 2
Magenta Ink Jettability Performance

| | | | Avg. | | |
|---|---|---|---|---|---|
| | | | Drop | | |
| | | | Weight | | |
| | | % | 2,000 | Drop | |
| Magenta | Decap | Missing | drops | Velocity | Decel |
| Ink ID | (7s) | Nozzles | 30 KHZ | m/s | m/s |
| Ex. M1 | 9 | 30.2 | 8.4 | 8.9 | 0.5 |
| Comp. M2 | 15 | 27.1 | 6.3 | 5.6 | 1 |
| Comp. M3 | 10 | 2.1 | 9.6 | 12 | 0 |

Ex. M1 performed as well or better than Comp. M3 (with a different polyurethane binder) in terms of decap, drop weight, and drop velocity. Ex. M1 performed better than Comp. M2 (polyurethane binder with higher acid number) in terms of decap and decel. It is believed that the performance of Ex. M1 can be improved by increasing the particle size of the polyurethane binder particles.

Example magenta prints were generated using Ex. M1. Comparative magenta prints were generated using Comp. M2 or Comp. M3. All of the magenta prints were generate without a fixer fluid. To generate the prints, the respective ink was thermal inkjet printed on Pakistan roll #1 (50:50 cotton/polyester blend, 175 GSM, knit) (PR #1) and GILDAN® 780 grey cotton T-shirts (G-780). The loading of the respective ink was 3 dpp (drops per pixel) (about 20 gsm). The prints were cured at 150° C. for 3 minutes.

All of the prints were analyzed for optical density. The initial optical density (initial OD) of each print (after heating) was measured. Then, the prints were washed 5 times in a Kenmore 90 Series Washer (Model 110.289 227 91) with warm water (at about 40° C.) and detergent. Each print was allowed to air dry between each wash. Then, the optical density (OD after 5 washes) of each print was measured. A smaller change in optical density (ΔOD) indicates that the color of the print has less fading.

All of the prints were also analyzed for washfastness. The L*a*b* values of a color (e.g., cyan, magenta, yellow, black) before and after the 5 washes were measured. L* is lightness, a* is the color channel for color opponents green-red, and b* is the color channel for color opponents blue-yellow. The color change was then calculated using both the CIEDE1976 color-difference formula (ΔE CMC) and the CIEDE2000 color-difference formula (ΔE 2000).

The CIEDE1976 color-difference formula is based on the CIELAB color space. Given a pair of color values in CIELAB space L*1 ,a*1,b*1 and L*2,a*2,b*2, the CIEDE1976 color difference between them is as follows:

ΔE_{CMC}={square root over ([L*₂−L*₁)²+(a*₂−a*₁)²+(b*₂−b*₁)²])}

The CIEDE2000 color-difference formula is based on the CIELAB color space. Given a pair of color values in CIELAB space L*1 ,a*1,b*1 and L*2,a*2,b*2, the CIEDE2000 color difference between them is as follows:

ΔE₀₀(L*₁,a*₁,b*₁;L*₂;L*₂,a*₂,b*₂)=ΔE₀₀¹²=ΔE₀₀

It is noted that ΔE₀₀ is the commonly accepted notation for CIEDE2000. With either calculation, a smaller change in ΔE indicates that the print is more durable.

TABLE 3
Magenta Prints Optical Density and Washfastness

| | Textile Fabric | | | | | |
|---|---|---|---|---|---|---|
| Magenta | PR#1 | | | G-780 | | |
| Print ID | ΔOD | ΔE₀₀ | ΔE_{CMC} | ΔOD | ΔE₀₀ | ΔE_{CMC} |
| Print M1 | −26.2 | 14.6 | 6 | −7.6 | 4.3 | 1.9 |
| Comp. | −19.6 | 11.8 | 4.7 | −7.7 | 4.6 | 2.1 |
| Print M2 | | | | | | |
| Comp. | −22 | 12.1 | 5 | −10.6 | 5.5 | 2.4 |
| Print M3 | | | | | | |

As shown in Table 3, the optical density and washfastness results for the magenta prints (Print M1) on cotton (G-780) were better than the comparative prints (Comp. Print M2 and Comp. Print M3). The results on the cotton/polyester blend (PR #1) were not as good, however, it is believed that these results may be significantly improved when the example magenta ink is printed with an example of the fixer fluid disclosed herein.

### Example 2

Seven example black inks (Ex. K5 through Ex. K11) including the sulfonated and carboxylated polyurethane binder particles disclosed herein were prepared with different examples of the sulfonated and carboxylated polyurethanes. Each had an acid number less than 10.

The example sulfonated and carboxylated polyurethane (Ex. SCPU 2) of Ex. K5 was prepared as follows:

74.158 g of polyester polyol (STEPANOL® PC-1015-55), 0.237 g of 2,2-bis(hydroxymethyl) propionic acid (i.e., Dimethylolpropionic Acid (DMPA)) and 18.355 g of 1,3-bis(isocyanatomethyl) cyclohexane (TAKENATE® 600, H6XDI) in 80 g of acetone were mixed in a 500 ml of 4-neck round bottom flask. A mechanical stirrer with glass rod and TEFLON® blade was attached. A condenser was also attached. The flask was immersed in a constant temperature bath at 75° C. The system was kept under a drying tube. 3 drops of dibutyltin dilaurate (DBTDL) was added to initiate the polymerization. Polymerization was continued for 6 hours at 75° C. 0.5 g samples were withdrawn for % NCO titration to confirm the reaction. The measured NCO value was 5.12% (theoretical % NCO should be 5.12%). This formed the pre-polymer solution. The polymerization temperature was reduced to 50° C. 4.208 g of isophorone diamine (IPD), 0.134 g of 50% sodium hydroxide aqueous solution, 6.084 g of sodium aminoalklysulphonate (A-95, 50% in water) and 15.210 g of deionized water were mixed in a beaker until IPD and A-95 are completely dissolved. The IPD and A-95 solution was added to the pre-polymer solution at 50° C. with vigorous stirring over 5 minutes. The solution became viscous and slight hazy. The mixture was stirred for 30 minutes at 50° C. Then 201.540 g of cold deionized water was added to polymer mixture in a 4-neck round bottom flask over 10 minutes with good agitation to form a polyurethane binder (PUB2) dispersion. The agitation was continued for 60 minutes at 50° C. PUB2 was filtered through 400 mesh stainless sieve. Acetone was removed with rotorvap at 50° C. (2 drops (20 mg) of BYK-011 de-foaming agent were added). The final PUB2 dispersion was filtered through fiber glass filter paper. The particle size measured by Malvern Zetasizer was 225.3 nm. The pH was 7. The solid content was 24.97%.

The example sulfonated and carboxylated polyurethane (Ex. SCPU 3) of Ex. K6 was prepared as follows:

72.876 g of polyester polyol (STEPANOL® PC-1015-55), 0.843 g of 2,2-bis(hydroxymethyl) propionic acid (i.e., Dimethylolpropionic Acid (DMPA)) and 20.643 g of isophorone diisocyanate (IPDI) in 80 g of acetone were mixed in a 500 ml of 4-neck round bottom flask. A mechanical stirrer with glass rod and TEFLON® blade was attached. A condenser was also attached. The flask was immersed in a constant temperature bath at 75° C. The system was kept under a drying tube. 3 drops of dibutyltin dilaurate (DBTDL) was added to initiate the polymerization. Polymerization was continued for 6 hours at 75° C. 0.5 g samples were withdrawn for % NCO titration to confirm the reaction. The measured NCO value was 4.53% (theoretical % NCO should be 4.53%). This formed the pre-polymer solution. The polymerization temperature was reduced to 50° C. 3.844 g of 2,2,4-trimethylhexane-1,6-diamine (TMD), 0.528 g of 50% sodium hydroxide aqueous solution, 3.587 g of sodium aminoalklysulphonate (A-95, 50% in water) and 8.968 g of deionized water were mixed in a beaker until TMD and A-95 were completely dissolved. The TMD and A-95 solution was added to the pre-polymer solution at 50° C. with vigorous stirring over 5 minutes. The solution became viscous and slight hazy. The mixture was stirred for 30 minutes at 50° C. Then 206.169 g of cold deionized water was added to polymer mixture in 4-neck round bottom flask over 10 minutes with good agitation to form a polyurethane binder (PUB3) dispersion. The agitation was continued for 60 minutes at 50° C. The PUB3 dispersion was filtered through 400 mesh stainless sieve. Acetone was removed with rotorvap at 50° C. (2 drops (20mg) of BYK-011 de-foaming agent were added). The final PUB3 dispersion was filtered through fiber glass filter paper. The particle size measured by Malvern Zetasizer was 218.3 nm. The pH was 7.5. The solid content was 32.37%.

The example sulfonated and carboxylated polyurethane (Ex. SCPU 4) of Ex. K7 was prepared as follows:

73.351 g of polyester polyol (STEPANOL® PC-1015-55), 0.424 g of 2,2-bis(hydroxymethyl) propionic acid (i.e., Dimethylolpropionic Acid (DMPA)) and 19.655 g of 2,2,4-trimethylhexane-1,6-diisocyanate (TMDI) in 80 g of acetone were mixed in a 500 ml of 4-neck round bottom flask. A mechanical stirrer with glass rod and TEFLON® blade was attached. A condenser was also attached. The flask was immersed in a constant temperature bath at 75° C. The system was kept under a drying tube. 3 drops of dibutyltin dilaurate (DBTDL) was added to initiate the polymerization. Polymerization was continued for 6 hours at 75° C. 0.5 g samples were withdrawn for % NCO titration to confirm the reaction. The measured NCO value was 4.89% (theoretical % NCO should be 4.89%). This formed the pre-polymer solution. The polymerization temperature was reduced to 50° C. 4.162 g of isophorone diamine (IPD), 0.266 g of 50% sodium hydroxide aqueous solution, 4.814 g of sodium aminoalklysulphonate (A-95, 50% in water) and 12.036 g of deionized water were mixed in a beaker until IPD and A-95 were completely dissolved. The IPD and A-95 solution was added to the pre-polymer solution at 50° C. with vigorous stirring over 5 minutes. The solution became viscous and slight hazy. The mixture was stirred for 30 minutes at 50° C. Then 204.034 g of cold deionized water was added to polymer mixture in 4-neck round bottom flask over 10 minutes with good agitation to form a polyurethane binder (PUB4) dispersion. The agitation was continued for 60 minutes at 50° C. The PUB4 dispersion was filtered through 400 mesh stainless sieve. Acetone was removed with rotorvap at 50° C. (2 drops (20mg) of BYK-011 de-foaming agent were added). The final PUB4 dispersion was filtered through fiber glass filter paper. The particle size measured by Malvern Zetasizer was 201.3 nm. The pH was 7.5. The solid content was 32.59%.

The example sulfonated and carboxylated polyurethane (Ex. SCPU 5) of Ex. K8 was prepared as follows:

72.764 g of polyester polyol (STEPANOL® PC-1015-55), 0.697 g of 2,2-bis(hydroxymethyl)butyric acid (i.e., dimethylol butanoic acid) and 20.611 g of isophorone diisocyanate (IPDI) in 80 g of acetone were mixed in a 500 ml of 4-neck round bottom flask. A mechanical stirrer with glass rod and TEFLON® blade was attached. A condenser was also attached. The flask was immersed in a constant temperature bath at 75° C. The system was kept under a drying tube. 3 drops of dibutyltin dilaurate (DBTDL) was added to initiate the polymerization. Polymerization was continued for 6 hours at 75° C. 0.5 g samples were withdrawn for % NCO titration to confirm the reaction. The measured NCO value was 4.53% (theoretical % NCO should be 4.53%). This formed the pre-polymer solution. The polymerization temperature was reduced to 50° C. 3.838 g of 2,2,4-trimethylhexane-1,6-diamine (TMD), 0.395 g of 50% sodium hydroxide aqueous solution, 4.179 g of sodium aminoalklysulphonate (A-95, 50% in water) and 10.447 g of deionized water were mixed in a beaker until TMD and A-95 were completely dissolved. The TMD and A-95 solution was added to the pre-polymer solution at 50° C. with vigorous stirring over 5 minutes. The solution became viscous and slight hazy. The mixture was stirred for 30 minutes at 50° C. Then, 204.980 g of cold deionized water was added to polymer mixture in 4-neck round bottom flask over 10 minutes with good agitation to form a polyurethane binder (PUBS) dispersion. The agitation was continued for 60 minutes at 50° C. The PUBS dispersion was filtered through 400 mesh stainless sieve. Acetone was removed with rotorvap at 50° C. (2 drops (20mg) of BYK-011 de-foaming agent were added). The final PUBS dispersion was filtered through fiber glass filter paper. The particle size measured by Malvern Zetasizer was 238.4 nm. The pH was 8. The solid content was 31.08%.

The example sulfonated and carboxylated polyurethane (Ex. SCPU 6) of Ex. K9 was prepared as follows:

72.812 g of polyester polyol (STEPANOL® PC-1015-55), 0.931 g of 2,2-bis(hydroxymethyl)butyric acid (i.e., dimethylol butanoic acid) and 20.625 g of isophorone diisocyanate (IPDI) in 80 g of acetone were mixed in a 500 ml of 4-neck round bottom flask. A mechanical stirrer with glass rod and TEFLON® blade was attached. A condenser was attached. The flask was immersed in a constant temperature bath at 75° C. The system was kept under drying tube. 3 drops of dibutyltin dilaurate (DBTDL) was added to initiate the polymerization. Polymerization was continued for 6 hours at 75° C. 0.5 g samples were withdrawn for % NCO titration to confirm the reaction. The measured NCO value was 4.52% (theoretical % NCO should be 4.52%). This formed the pre-polymer solution. The polymerization temperature was reduced to 50° C. 3.840 g of 2,2,4-trimethylhexane-1,6-diamine (TMD), 0.528 g of 50% sodium hydroxide aqueous solution, 3.584 g of sodium aminoalklysulphonate (A-95, 50% in water) and 8.960 g of deionized water were mixed in a beaker until TMD and A-95 were completely dissolved. The TMD and A-95 solution was added to the pre-polymer solution at 50° C. with vigorous stirring over 5 minutes. The solution became viscous and slight hazy. The mixture was stirred for 30 minutes at 50° C. Then, 206.172 g of cold deionized water was added to polymer mixture in 4-neck round bottom flask over 10 minutes with good agitation to form a polyurethane binder (PUB6) dispersion. The agitation was continued for 60 minutes at 50° C. The PUB6 dispersion was filtered through 400 mesh stainless sieve. Acetone was removed with rotorvap at 50° C. (2 drops (20 mg) of BYK-011 de-foaming agent were added). The final PUB6 dispersion was filtered through fiber glass filter paper. The particle size measured by Malvern Zetasizer was 258.2 nm. The pH was 7. The solid content was 30.96%.

The example sulfonated and carboxylated polyurethane (Ex. SCPU 7) of Ex. K10 was prepared as follows:

73.270 g of polyester polyol (STEPANOL® PC-1015-55), 0.234 g of 2,2-bis(hydroxymethyl)butyric acid (i.e., dimethylol butanoic acid) and 19.633 g of 2,2,4-trimethylhexane-1,6-diisocyanate (TMDI) in 80 g of acetone were mixed in a 500 ml of 4-neck round bottom flask. A mechanical stirrer with glass rod and TEFLON® blade was attached. A condenser was also attached. The flask was immersed in a constant temperature bath at 75° C. The system was kept under a drying tube. 3 drops of dibutyltin dilaurate (DBTDL) were added to initiate the polymerization. Polymerization was continued for 6 hourrs at 75° C. 0.5 g samples were withdrawn for % NCO titration to confirm the reaction. The measured NCO value was 5.04% (theoretical % NCO should be 5.04%). This formed the pre-polymer solution. The polymerization temperature was reduced to 50° C. 4.158 g of isophorone diamine (IPD), 0.133 g of 50% sodium hydroxide aqueous solution, 4.814 g of sodium aminoalklysulphonate (A-95, 50% in water) and 13.525 g of deionized water were mixed in a beaker until IPD and A-95 were completely dissolved. The IPD and A-95 solution was added to the pre-polymer solution at 50° C. with vigorous stirring over 5 minutes. The solution became viscous and slight hazy. The mixture was stirred for 30 minutes at 50° C. Then, 202.837 g of cold deionized water was added to polymer mixture in 4-neck round bottom flask over 10 minutes with good agitation to form a polyurethane binder (PUB7) dispersion. The agitation was continued for 60 minutes at 50° C. The PUB7 dispersion was filtered through 400 mesh stainless sieve. Acetone was removed with rotorvap at 50° C. (2 drops (20 mg) of BYK-011 de-foaming agent were added). The final PUB7 dispersion was filtered through fiber glass filter paper. she particle size measured by Malvern Zetasizer was 267.6 nm. The pH was 7. The solid content was 24.59%.

The example sulfonated and carboxylated polyurethane (Ex. SCPU 8) of Ex. K11 was prepared as follows:

73.319 g of polyester polyol (STEPANOL® PC-1015-55), 0.469 g of 2,2-bis(hydroxymethyl)butyric acid (i.e., dimethylol butanoic acid) and 19.648 g of 2,2,4-trimethylhexane-1,6-diisocyanate (TMDI) in 80 g of acetone were mixed in a 500 ml of 4-neck round bottom flask. A mechanical stirrer with glass rod and TEFLON® blade was attached. A condenser was also attached. The flask was immersed in a constant temperature bath at 75° C. The system was kept under a drying tube. 3 drops of dibutyltin dilaurate (DBTDL) were added to initiate the polymerization. Polymerization was continued for 6 hours at 75° C. 0.5 g samples were withdrawn for % NCO titration to confirm the reaction. The measured NCO value was 4.88% (theoretical % NCO should be 4.88%). This formed the pre-polymer solution. The polymerization temperature was reduced to 50° C. 4.160 g of isophorone diamine (IPD), 0.266 g of 50% sodium hydroxide aqueous solution, 4.812 g of sodium aminoalklysulphonate (A-95, 50% in water) and 12.030 g of deionized water were mixed in a beaker until IPD and A-95 were completely dissolved. The IPD and A-95 solution was added to the pre-polymer solution at 50° C. with vigorous stirring over 5 minutes. The solution became viscous and slight hazy. The mixture was stirred for 30 minutes at 50° C. Then 204.036 g of cold deionized water was added to polymer mixture in 4-neck round bottom flask over 10 minutes with good agitation to form a polyurethane binder (PUB8) dispersion. The agitation was continued for 60 minutes at 50° C. The PUB8 dispersion was filtered through 400 mesh stainless sieve. Acetone was removed with rotorvap at 50° C. (2 drops (20 mg) of BYK-011 de-foaming agent were added). The final PUB8 dispersion was filtered through fiber glass filter paper. The particle size measured by Malvern Zetasizer was 231.8 nm. The pH was 7. The solid content was 19.9%.

A comparative example black ink (Comp. K4) including sulfonated and carboxylated polyurethane binder particles was also prepared. This sulfonated and carboxylated polyurethane had an acid number of 12.2 due to a higher number of carboxylic acid groups.

A comparative sulfonated and carboxylated polyurethane (Comp. SCPU 2) of Comp. K4 was prepared as follows:

72.015 g of polyester polyol (STEPANOL® PC-1015-55), 0.833 g of 2,2-bis(hydroxymethyl) propionic acid (i.e., dimethylol butanoic acid) and 20.399 g of isophorone diisocyanate (IPDI) in 80 g of acetone were mixed in a 500 ml of 4-neck round bottom flask. A mechanical stirrer with glass rod and TEFLON® blade was attached. A condenser was also attached. The flask was immersed in a constant temperature bath at 75° C. The system was kept under a drying tube. 3 drops of dibutyltin dilaurate (DBTDL) were added to initiate the polymerization. Polymerization was continued for 6 hrs at 75° C. 0.5 g samples were withdrawn for % NCO titration to confirm the reaction. The measured NCO value was 4.53% (theoretical % NCO should be 4.53%). This formed the pre-polymer solution. The polymerization temperature was reduced to 50° C. 3.798 g of 2,2,4-trimethylhexane-1,6-diamine (TMD), 0.522 g of 50% sodium hydroxide aqueous solution, 5.908 g of sodium aminoalklysulphonate (A-95, 50% in water) and 14.771 g of deionized water are mixed in a beaker until TMD and A-95 is completely dissolved. The TMD and A-95 solution was added to the pre-polymer solution at 50° C. with vigorous stirring over 5 minutes. The solution became viscous and slight hazy. The mixture was stirred for 30 minutes at 50° C. Then 201.482 g of cold deionized water was added to polymer mixture in 4-neck round bottom flask over 10 minutes with good agitation to form a comparative polyurethane PUB dispersion. The agitation was continued for 60 minutes at 50° C. This comparative PUB dispersion was filtered through 400 mesh stainless sieve. Acetone was removed with rotorvap at 50° C. (2 drops (20 mg) of BYK-011 de-foaming agent were added). The final comparative PUB dispersion was filtered through fiber glass filter paper. The particle size measured by Malvern Zetasizer was 65.37 nm. The pH was 7.5. The solid content was 30.57%.

Another comparative example black ink (Comp. K12) was prepared with a comparative polyurethane, namely an anionic aliphatic polyester-polyurethane binder (IMPRANIL® DLN-SD (Acid Number 5.2) from Covestro).

Still another comparative example black ink (Comp. K13) was prepared with a comparative polyurethane including sulfonate groups, but no carboxylate groups. The comparative sulfonated polyurethane (Comp. SPU) of Comp. K13 was prepared as follows:

72.6 g of polyester polyol (STEPANOL® PC-1015-55), and 20.6 g of isophorone diisocyanate (IPDI) in 80 g of acetone were mixed in a 500 ml 4-neck round bottom flask. A mechanical stirrer with glass rod and TEFLON® blade was attached. A condenser was also attached. The flask was immersed in a constant temperature bath at 75° C. The system was kept under a drying tube. 3 drops of dibutyltin dilaurate (DBTDL) was added to initiate the polymerization. Polymerization was continued for 6 hours at 75° C. About 0.5 g samples were withdrawn for % NCO titration to confirm the reaction. The measured NCO value was 5.10%. Theoretical % NCO should be 5.13%.

The polymerization temperature was reduced to 50° C. 3.8 g of 2,2,4-trimethylhexane-1,6-diamine (TMD), 5.9 g of sodium aminoalklysulphonate (A-95, 50% in water) and about 14.8 g of deionized water were mixed in a beaker until TMD and A-95 were completely dissolved. The TMD and A-95 solution was added to the pre-polymer solution at 50° C. with vigorous stirring over 5 minutes. The solution became viscous and slight hazy. Stirring was continued for about 30 minutes at 50° C. Then, about 201.7 g of cold deionized water was added to polymer mixture in a 4-neck round bottom flask over 10 minutes with good agitation to form the sulfonated only polyurethane binder dispersion. The agitation was continued for 60 minutes at 50° C. The sulfonated only polyurethane binder dispersion was filtered through 400 mesh stainless sieve. Acetone was removed with rotorvap at 50° C. (added 2 drops (20 mg) BYK-011 de-foaming agent to control foaming). The final sulfonated only polyurethane binder dispersion was filtered through fiber glass filter paper. The D50 particle size measured by Malvern Zetasizer was 156.8 nm. The pH was 7.0. The solid content was 34.5%.

The black ink formulations are shown in Tables 4A and 4B.

TABLE 4A
Example Black Inks

| | | Ex. | Ex. | Ex. | Ex. | Ex. | Ex. | Ex. |
|---|---|---|---|---|---|---|---|---|
| | | K5 | K6 | K7 | K8 | K9 | K10 | K11 |
| | Specific | (wt % | (wt % | (wt % | (wt % | (wt % | (wt % | (wt % |
| Ingredient | Component | active) | active) | active) | active) | active) | active) | active) |
| Pigment | Black pigment | 5 | 5 | 5 | 5 | 5 | 5 | 5 |
| dispersion | dispersion | | | | | | | |
| | available from | | | | | | | |
| | DIC | | | | | | | |
| Binder | Ex. SCPU 2 | 6 | 0 | 0 | 0 | 0 | 0 | 0 |
| | Ex. SCPU 3 | 0 | 6 | 0 | 0 | 0 | 0 | 0 |
| | Ex. SCPU 4 | 0 | 0 | 6 | 0 | 0 | 0 | 0 |
| | Ex. SCPU 5 | 0 | 0 | 0 | 6 | 0 | 0 | 0 |
| | Ex. SCPU 6 | 0 | 0 | 0 | 0 | 6 | 0 | 0 |
| | Ex. SCPU 7 | 0 | 0 | 0 | 0 | 0 | 6 | 0 |
| | Ex. SCPU 8 | 0 | 0 | 0 | 0 | 0 | 0 | 6 |
| Co-solvent | Glycerol | 6 | 6 | 6 | 6 | 6 | 6 | 6 |
| Anti-decel | LIPONIC ® | 1 | 1 | 1 | 1 | 1 | 1 | 1 |
| agent | EG-1 | | | | | | | |
| Anti-kogation | CRODAFOS ™ | 0.5 | 0.5 | 0.5 | 0.5 | 0.5 | 0.5 | 0.5 |
| agent | N-3A | | | | | | | |
| Surfactant | SURFYNOL ® | 0.3 | 0.3 | 0.3 | 0.3 | 0.3 | 0.3 | 0.3 |
| | 440 | | | | | | | |
| Antimicrobial | ACTICIDE ® | 0.044 | 0.044 | 0.044 | 0.044 | 0.044 | 0.044 | 0.044 |
| agent | B20 | | | | | | | |
| Water | Deionized | Bal. | Bal. | Bal. | Bal. | Bal. | Bal. | Bal. |
| | water | | | | | | | |

TABLE 4B
Comparative Example Black Inks

| | | Comp. K4 | Comp. K12 | Comp. K12 |
|---|---|---|---|---|
| | Specific | (wt % | (wt % | (wt % |
| Ingredient | Component | active) | active) | active) |
| Pigment | Black pigment | 5 | 5 | 5 |
| dispersion | dispersion | | | |
| | available | | | |
| | from DIC | | | |
| Binder | Comp. SCPU2 | 6 | 0 | 0 |
| | IMPRANIL ® | 0 | 6 | 0 |
| | DLN-SD | | | |
| | Comp. SPU | 0 | 0 | 6 |
| Co-solvent | Glycerol | 6 | 6 | 6 |
| Anti-decel | LIPONIC ® | 1 | 1 | 1 |
| agent | EG-1 | | | |
| Anti-kogation | CRODAFOS ™ | 0.5 | 0.5 | 0.5 |
| agent | N-3A | | | |
| Surfactant | SURFYNOL ® | 0.3 | 0.3 | 0.3 |
| | 440 | | | |
| Antimicrobial | ACTICIDE ® | 0.044 | 0.044 | 0.044 |
| agent | B20 | | | |
| Water | Deionized water | Balance | Balance | Balance |

The jettability performance of each of the example black inks (Ex. K5-Ex. K11) and some of the comparative example black inks (Comp. K4 and Comp. K12) was tested. The black inks were printed using a thermal inkjet printer. The jettability performance was evaluated for decap, missing nozzles, drop weight, drop velocity, decel performance as described in Example 1. In this example, decap was given a score ranging from T1 to T5, where T1 indicates that a good line was not obtained after 15 spits, T3 indicates a good line was obtained after 7 spits, and T5 indicates a good line was obtained after 1 spit.

The jettability performance results for the black ink are shown in Table 5A.

TABLE 5A
Black Ink Jettability Performance

| | | | Avg. | | |
|---|---|---|---|---|---|
| | | | Drop | | |
| | | | Weight | | |
| | | | 2,000 | Drop | |
| Black | Decap | % Missing | drops | Velocity | Decel |
| Ink ID | (7s) | nozzles | 30 KHZ | (m/s) | (m/s) |
| Comp. | N/A | N/A | 3.1 | N/A | Data too |
| K4 | | | | | noisy |
| Ex. K5 | T3 | 2.1 | 11.9 | 11 | 0 |
| Ex. K6 | T3 | 2.1 | 12.6 | 11.3 | 0 |
| Ex. K7 | T3 | 4.2 | 12.1 | 10.5 | 0 |
| Ex. K8 | T3 | 2.1 | 12.8 | 11.3 | 0 |
| Ex. K9 | T3 | 0 | 12.5 | 10.9 | 0 |
| Ex. | T3 | 2.1 | 12.9 | 10.9 | 0 |
| K10 | | | | | |
| Ex. | T3 | 6.3 | 11.9 | 11.2 | 0 |
| K11 | | | | | |
| Comp. | T3 | 7.3 | 10.3 | 10.2 | 0 |
| K12 | | | | | |

The results shown in Table 5A indicate that the comparative black ink K4 was unable to be evaluated as it was unable to be printed via digital inkjet printheads. Comp. K4, formed with a sulfonated and carboxylated polyurethane having an acid number over 10, was not jettable. The example black inks K5-K10 indicated good jettability, shown by acceptable decap and decel performance, good dropweight and drop velocity, and a low percent of missing nozzles. Example black ink K11 had a slightly higher percentage of missing nozzles, as did the comparative black ink K12.

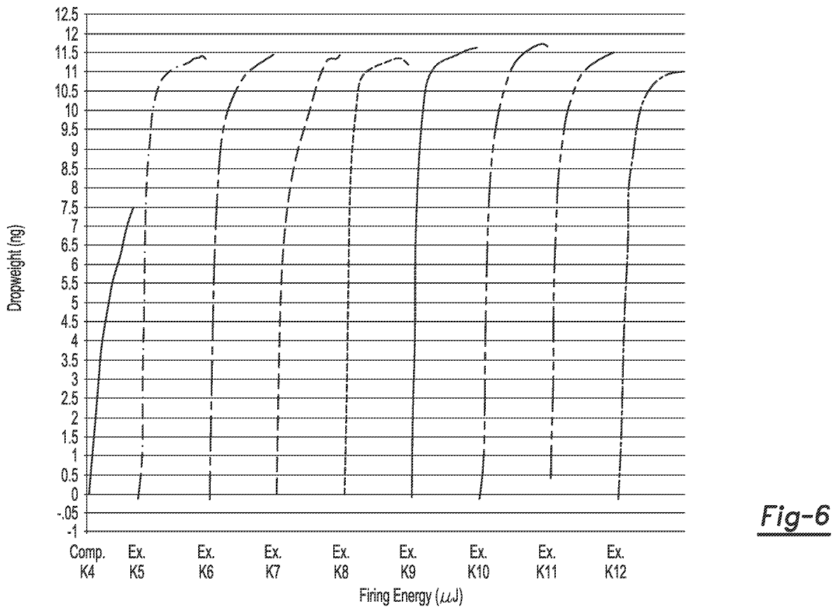

FIG. 6 displays Turn-On-Energy (TOE) curves for the seven example black inkjet inks, and the two comparative example black inkjet inks (Comparative K4 and Comparative K12), plotting drop weight in nanograms (ng) vs. firing energy in microJoules (μJ). The comparative black ink K4 did not show a desirable TOE curve. The other example black inkjet inks K5-K11 and comparative ink K12 showed acceptable TOE curves, exhibiting good jettability.

The example black inks (Ex. K5-Ex. K11) and some of the comparative example black inks (Comp. K4 and Comp. K12) were also tested for stability.

The noted example and comparative example black inks were stored in an accelerated storage (AS) or accelerated shelf life (ASL) environment at a temperature of 60° C. for one week. The particle size, viscosity, and pH for each example and comparative example black inks was measured before and after the inks were stored in the AS environment. The particle size for each example and comparative example black ink was measured in terms of the volume-weighted mean diameter (Mv) and the D95 (i.e., 95% the population is below this value) using dynamic light scattering with a NANOTRAC® WAVE™ particle size analyzer (available from MICROTRAC™-NIKKISO GROUP™). The initial particle size (volume-weighted mean diameter (Mv)) of the example and comparative example black inks were within the range of 0.110-0.145 μm. The viscosity of each example and comparative example black inks was measured at 25° C. at a shear rate of 3000 s⁻¹. The initial viscosities of the example and comparative example black inks were within the range of 2.3-2.6 Ns/m². The pH of each example and comparative example black inks was measured with a suitable pH meter. The initial pH of the example and comparative example black inks were within the range of 9.11-9.25. Then the percent change (% Δ) in particle size, viscosity, and pH, respectively, was then calculated for each example and comparative example black ink after 1 week ASL. The particle size percent change, the viscosity percent change, and the pH percent change for each example and comparative example black ink are shown in Table 5B.

TABLE 5B
Black Ink Stability Performance ASL

| | % Δ | % Δ | | |
|---|---|---|---|---|
| | Particle | Particle | | |
| Black | size | size | % Δ | % Δ |
| Ink | after AS | after AS | Viscosity | pH after |
| ID | (Mv) | (D95) | after AS | AS |
| Comp. K4 | −6.6 | −5.7 | −4.2 | −0.43 |
| Ex. K5 | −2.1 | 1.9 | −4 | −0.35 |
| Ex. K6 | −1.3 | 2.5 | −4.2 | −0.35 |
| Ex. K7 | −2.9 | −6 | −4.2 | −0.3 |
| Ex. K8 | 1 | 12.6 | −4.2 | −0.39 |
| Ex. K9 | −4.2 | −6.1 | 4.3 | −0.39 |
| Ex. K10 | −1.3 | 2.7 | 0 | −0.29 |
| Ex. K11 | −4.4 | −15 | 0 | −0.35 |
| Comp. | −7.3 | −11.9 | −8.3 | −0.51 |
| K12 | | | | |

The results from Table 5B indicate that the example and comparative example black inks had acceptable accelerated shelf life stability results, with little to no change in properties such as particle size, viscosity, and pH.

Additionally, each example and comparative example black ink was put through a T-cycle. During the T-cycle, each example and comparative example dispersion was heated to and maintained at a high temperature of 70° C. for 4 hours, and then each ink was cooled to and maintained at a low temperature of −40° C. for 4 hours. This process was repeated for each example and comparative example black ink for 5 cycles. For each example and comparative example black ink, the particle size (in terms of Mv and D95), the viscosity, and the pH was measured before and after the T-cycle, and the percent change in particle size, viscosity, and pH was calculated. The results of the particle size percent change, viscosity percent change, and pH percent change are shown below in Table 5C.

TABLE 5C
Black Ink Stability Performance T-Cycle

| | % Δ | % Δ | | |
|---|---|---|---|---|
| | Particle | Particle | | |
| | size | size | % Δ | % Δ |
| | after T- | after T- | Viscosity | PH |
| Black Ink | Cycle | Cycle | after | after |
| ID | (Mv) | (D95) | T-Cycle | T-Cycle |
| Comp. K4 | −5.7 | −0.1 | −4.2 | −0.07 |
| Ex. K5 | −5.1 | −10.3 | 0 | −0.07 |
| Ex. K6 | −2.7 | −1.8 | 0 | −0.03 |
| Ex. K7 | −3.7 | −8.3 | 0 | 0.04 |
| Ex. K8 | −1.9 | −1.4 | −4.2 | −0.12 |
| Ex. K9 | −2.2 | −1.1 | 4.3 | −0.09 |
| Ex. K10 | −2.5 | 2.2 | 0 | −0.15 |
| Ex. K11 | −0.8 | −3.9 | 0 | −0.14 |
| Comp. | −3.9 | −1.2 | −4.2 | −0.12 |
| K12 | | | | |

The results from Table 5C indicate that the example and comparative example black inks had acceptable T-cycle stability results, with little to no change in properties such as particle size, viscosity, and pH.

Example black prints were generated using the following example black inks: Ex. K5, Ex. K6, and Ex. K8-Ex. K11. Comparative black prints were generated using each of the comparative example black inks (Comp. K4, Comp. K12, and Comp. K13). All of the black prints were generated with a fixer fluid. The formulation of the fixer fluid included: 4 wt % active of a co-solvent (2-methyl-1,3-propanediol), 0.5 wt % active of a phosphate ester surfactant (CRODAFOS™ O3A), 0.4 wt % active of a surfactant (SURFYNOL® 440), 4 wt % active of an azetidinium-containing polyamine (POLYCUP™ 7360A available from Solenis LLC), and a balance of deionized water.

To generate the prints, the fixer fluid and then the respective ink were thermal inkjet printed on different textile fabrics: Pakistan roll #1 (50:50 cotton/polyester blend, 175 GSM, knit) (PR #1), Pakistan roll # 4 (100% cotton, 150 GSM, knit) (PR #4), and GILDAN® 780 grey cotton T-shirts (G-780). The loading of the fixer fluid was about 10 gsm (1.5 dpp) and the loading of the respective ink was about 20 gsm (3 dpp). The prints were cured at 150° C. for 3 minutes.

Some of the black prints on PR #1 and G-780 were tested for optical density and washfastness using the CIEDE1976 color-difference formula (ΔE CMC), as described in Example 1. The results are shown in Table 6.

TABLE 6
Black Prints Optical Density and Washfastness

| | Textile Fabric | | | |
|---|---|---|---|---|
| Black Print | PR#1 | | G-780 | |
| ID | ΔOD | ΔE_{CMC} | ΔOD | ΔE_{CMC} |
| Comp. Print | −8.1 | 3.3 | −11.9 | 4.4 |
| K4 | | | | |
| Ex. Print K5 | −8.7 | 4.1 | −10.9 | 5 |
| Ex. Print K6 | −8.5 | 4 | −8.4 | 5.2 |
| Ex. Print K8 | −8 | 3.9 | −8.8 | 5 |
| Ex. Print K9 | −11.1 | 4.2 | −11.6 | 5.4 |
| Ex. Print K10 | −12 | 4.3 | −11.2 | 5.4 |
| Ex. Print K11 | −6.3 | 3.8 | −9.2 | 5 |
| Comp. Print | −18 | 6 | −13.5 | 6.6 |
| K12 | | | | |

Durability was relatively consistent across the comparative and example prints.

All of the black prints were also tested for crock-fastness. To test crock-fastness, a cloth was wet with water. While wet, the cloth was rubbed across the print. The durability of the print was assessed by its ability to resist ink removal when rubbed with the wet cloth. The wet crock-fastness was evaluated visually with the American Association of Textile Chemists and Colorists (AATCC) color chart, and rated on a scale from 1-5 (1=complete ink removal and 5=no ink removal). The results are shown in Table 7 below.

TABLE 7
Wet Crock-fastness of Black Inks

| | Textile Fabric | | |
|---|---|---|---|
| Black Print | PR# | | |
| ID | 1 | PR#4 | G-780 |
| Comp. Print | 4 | 3 | 3 |
| K4 | | | |
| Ex. Print K5 | 3 | 3 | 2 |
| Ex. Print K6 | 4 | 4 | 4 |
| Ex. Print K8 | 3 | 3 | 3 |
| Ex. Print K9 | 3 | 3 | 3 |
| Ex. Print K10 | 3 | 3 | 3 |
| Ex. Print K11 | 3 | 3 | 3 |
| Comp. Print | 3 | 3 | 2 |
| K12 | | | |
| Comp. Print | 2 | 2 | 2 |
| K13 | | | |

As illustrated in Table 7, the example inks performed on par with Comp. K4 (similar polyurethane with higher acid number) and Comp. K12 (different polyurethane). The example inks generally performed better than the fully sulfonated polyurethane (Comp. K13).

All of the results in Examples 1 and 2 illustrate that the sulfonated and carboxylated polyurethane enable a balance between reliable jettability and durability to be obtained.

It is to be understood that the ranges provided herein include the stated range and any value or sub-range within the stated range, as if the value(s) or sub-range(s) within the stated range were explicitly recited. For example, a range from about 0.1 wt % active to about 30 wt % active, should be interpreted to include not only the explicitly recited limits of from about 0.1 wt % active to about 30 wt % active, but also to include individual values, such as about 0.15 wt % active, about 12.5 wt % active, 14.0 wt % active, 26.77 wt % active, 28 wt % active, etc., and sub-ranges, such as from about 5 wt % active to about 15 wt % active, from about 3 wt % active to about 25 wt % active, from about 10 wt % active to about 20 wt % active, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A multi-fluid kit for textile printing, comprising:
an inkjet ink including:
a self-crosslinked polyurethane binder particle including a polyurethane polymer with a polymerized carboxylate-based diol and a polymerized sulfonated diamine;
a pigment; and
an ink aqueous vehicle; and
a fixer fluid including:
an azetidinium-containing polyamine; and
a fixer aqueous vehicle.

2. The multi-fluid kit as defined in claim 1, wherein the polyurethane polymer consists of the polymerized carboxylate-based diol, the polymerized sulfonated diamine, a polymerized diisocyanate, a polymerized polymeric diol, and a polymerized non-ionic diamine.

3. The multi-fluid kit as defined in claim 2, wherein the polymerized carboxylate-based diol includes polymerized dimethylol propionic acid or polymerized dimethylol butanoic acid.

4. The multi-fluid kit as defined in claim 1, wherein the polyurethane polymer has an acid number of or 10 or less, a weight average molecular weight ranging from about 25,000 g/mol to about 1,000, 000 g/mol, and a particle size ranging from about 150 nm to about 350 nm.

5. The multi-fluid kit as defined in claim 1, wherein the polyurethane polymer is present in an amount ranging from about 0.1 wt % active to about 30 wt % active based on a total weight of the inkjet ink.

6. The multi-fluid kit as defined in claim 1, wherein the pigment is present in an amount ranging from about 0.5 wt % active to about 15 wt % active based on a total weight of the inkjet ink.

7. The multi-fluid kit as defined in claim 1, wherein the ink aqueous vehicle consists of water or water, a co-solvent, and an additive selected from the group consisting of a surfactant, an anti-kogation agent, an anti-decel agent, an antimicrobial agent, and combinations thereof.

8. The multi-fluid kit as defined in claim 1, wherein the ink aqueous vehicle is present in an amount of at least 30 wt % based on a total weight of the inkjet ink.

9. The multi-fluid kit as defined in claim 1, wherein the azetidinium-containing polyamine has a structure: 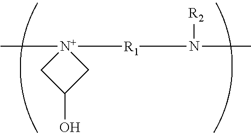
where R₁ can be a substituted or unsubstituted C₂-C₁₂ linear alkyl group and R₂ is H or CH₃.

10. The multi-fluid kit as defined in claim 1, wherein the azetidinium-containing polyamine is present in an amount of about 1 wt % active to about 15 wt % active based on a total weight of the fixer fluid.

11. A textile printing kit, comprising:
a textile fabric;
an inkjet ink including:
a self-crosslinked polyurethane binder particle including a polyurethane polymer with a polymerized carboxylate-based diol and a polymerized sulfonated diamine;
a pigment; and
an ink aqueous vehicle; and
a fixer fluid including:
an azetidinium-containing polyamine; and
a fixer aqueous vehicle.

12. The textile printing kit as defined in claim 11, wherein the textile fabric is a woven or knitted fabric.

13. A method for forming a printed image on a textile fabric, comprising:
applying a fixer fluid on at least a portion of the textile fabric to generate a pre-treated portion of the textile fabric, the fixer fluid including:
an azetidinium-containing polyamine; and
a fixer aqueous vehicle; and
applying an inkjet ink on at least a portion of the pre-treated portion of the textile fabric, the inkjet ink including:
a self-crosslinked polyurethane binder particle including a polyurethane polymer with a polymerized carboxylate-based diol and a sulfonated diamine;
a pigment; and
an ink aqueous vehicle.

14. The method as defined in claim 13, wherein the fixer fluid and the inkjet ink are applied using a thermal inkjet printer.

15. The method as defined in claim 13, further comprising exposing the textile fabric having the printed image thereon to a thermal curing process.
